(19) United States
(12) Patent Application Publication
(10) Pub. No.: US 2024/0376254 A1
(43) Pub. Date: Nov. 14, 2024

(54) NOVEL DEUTERATED POLYMERS FOR ELECTROCHEMICAL REACTIONS

(71) Applicant: UOP LLC, Des Plaines, IL (US)

(72) Inventors: Chunqing Liu, Arlington Heights, IL (US); Jeffery C. Bricker, Buffalo Grove, IL (US)

(21) Appl. No.: 18/438,762

(22) Filed: Feb. 12, 2024

Related U.S. Application Data
(60) Provisional application No. 63/501,915, filed on May 12, 2023.

(51) Int. Cl. C08G 61/12; B01J 41/07; B01J 41/13; B01J 47/12

(52) U.S. Cl. CPC C08G 61/122; B01J 41/07; B01J 41/13; B01J 47/12; C08G 2261/122; C08G 2261/124; C08G 2261/312; C08G 2261/314; C08G 2261/334; C08G 2261/42; C08G 2261/72

(57) ABSTRACT

Deuterated anion exchange polymers, methods of making the deuterated anion exchange polymers, anion exchange membranes comprising the deuterated anion exchange polymers, and membrane electrode assemblies comprising the deuterated anion exchange polymers are described. The deuterated anion exchange polymers comprise a plurality of repeating units of formula (I)

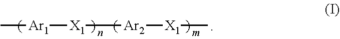

### RELATED APPLICATIONS

This application claims priority to U.S. Provisional Patent Application Ser. No. 63/501,915, filed on May 12, 2023, the entirety of which is incorporated herein by reference.

### BACKGROUND

Renewable energy sources, such as wind and solar power, have transient characteristics, which require energy storage. Renewable energy storage systems such as redox flow batteries (RFBs) have attracted significant attention for electricity grid, electric vehicles, and other large-scale stationary applications. RFB is an electrochemical energy storage system that reversibly converts chemical energy directly to electricity. The conversion of electricity via water electrolysis into hydrogen as an energy carrier without generation of carbon monoxide or dioxide as byproducts enables a coupling of the electricity, chemical, mobility, and heating sectors.

The electrochemical conversion of CO₂ via CO₂ electrolysis using renewably generated electricity is an appealing approach for the production of sustainable hydrocarbons, alcohols, and carbonyl products widely used in numerous industrial sectors.

Hydrogen as an energy vector for grid balancing or power-to-gas and power-to-liquid processes plays an important role in the path toward a low-carbon energy structure that is environmentally friendly. Water electrolysis produces high quality hydrogen by electrochemically splitting water into hydrogen and oxygen; the reaction is given by Eq. 1 below. The water electrolysis process is an endothermic process, and electricity is the energy source. Water electrolysis has zero carbon footprint when the process is powered by renewable energy sources, such as wind, solar, or geothermal energy. The main water electrolysis technologies include alkaline electrolysis, proton exchange membrane (PEM) water electrolysis as shown in FIG. 1, anion exchange membrane (AEM) water electrolysis as shown in FIG. 2, and solid oxide water electrolysis.

As shown in FIG. 1, in a PEMWE system 100, an anode 105 and a cathode 110 are separated by a solid PEM electrolyte 115, such as a sulfonated tetrafluoroethylene based cofluoropolymer sold under the trademark Nafion™ by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive fluorinated PEM.

Water electrolysis reaction: 2H₂O→2H₂+O₂ (1)

Oxidation reaction at anode for PEMWE: 2H₂O→O₂+4H⁺+4e⁻ (2)

Reduction reaction at cathode for PEMWE: 2H⁺+2e⁻→H₂ (3)

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%.

Reduction reaction at cathode for AEMWE: 4H₂O+4e⁻→2H₂+4OH⁻ (4)

Oxidation reaction at anode for AEMWE: 4OH⁻→2H₂O+O₂+4e⁻ (5)

AEMWE has an advantage over PEMWE because it permits the use of less expensive platinum metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are membrane hydroxyl ion conductivity and stability, as well as lack of understanding of how to integrate catalysts into AEM systems. Research on AEMWE in the literature has been focused on developing electrocatalysts, AEMs, and understanding the operational mechanisms with the general objective of obtaining a high efficiency, low cost and stable AEMWE technology.

Fuel cells, as a next generation clean energy resource, convert the energy of chemical reactions such as an oxidation/reduction redox reaction of hydrogen and oxygen into electric energy. The three main types of fuel cells are alkaline electrolyte fuel cells, polymer electrolyte membrane fuel cells, and solid oxide fuel cells. Polymer electrolyte membrane fuel cells may include proton exchange membrane fuel cells (PEMFC), anion exchange membrane fuel cells (AEMFC), and direct methanol fuel cells. PEMFC uses a PEM to conduct protons from the anode to the cathode, and it also separates the H₂ and O₂ gases to prevent gas crossover. AEMFC uses an AEM to conduct OH⁻ from the cathode to the anode, and it also separates the H₂ and O₂ gases to prevent gas crossover.

Redox flow batteries (RFBs) comprise two external storage tanks filled with active materials comprising metal ions that may be in different valance states, two circulation pumps, and a flow cell with a separation membrane and two electrodes. The separation membrane is located between the anode and the cathode and is used to separate the anolyte and the catholyte, as well as to utilize the current circuit by allowing the transfer of balancing ions. The anolyte, catholyte, anode, and cathode may also be referred to as plating electrolyte or negative electrolyte, redox electrolyte or positive electrolyte, plating electrode or negative electrode, and redox electrode or positive electrode respectively. Among all the redox flow batteries developed to date, all vanadium redox flow batteries (VRFB) have been the most extensively studied. VRFB uses the same vanadium element in both half cells which prevents crossover contamination of electrolytes from one half cell to the other half cell. VRFB, however, is inherently expensive due to the use of high-cost vanadium and an expensive membrane. All-iron redox flow batteries (IFB) are particularly attractive for grid scale storage applications due to the use of low cost and abundantly available iron, salt, and water as the electrolyte and the non-toxic nature of the system.

The membrane is one of the key materials that make up a battery, an electrolysis cell, or a fuel cell, and it is an important driver for safety and performance. Some important properties for membranes for flow batteries, fuel cells, and membrane electrolysis include high conductivity, high ionic permeability, high ionic exchange capacity (for ion-exchange membrane), high ionic/H₂ and O₂ selectivity (low H₂ and O₂ permeability/crossover) or high ionic/electrolyte selectivity (low permeability/crossover to electrolytes), low price, low area resistance to minimize efficiency loss resulting from ohmic polarization, high resistance to oxidizing and reducing conditions, being chemically inert at a wide pH range, high thermal stability together with high proton conductivity (greater than or equal to 120° C. for fuel cell), high proton conductivity at high temperature without H₂O, high proton conductivity at high temperature with maintained high relative humidity, and high mechanical strength (thickness, low swelling).

Significant advances are needed in cost-effective, high performance, stable ion exchange polymers, membranes, catalyst-coated membranes (CCMs), and other cell stack components for electrolysis, fuel cells, and energy storage with a wide range of applications in renewable energy systems.

### BRIEF DESCRIPTION OF THE DRAWINGS

FIG. 1 is an illustration of one embodiment of a PEMWE cell.

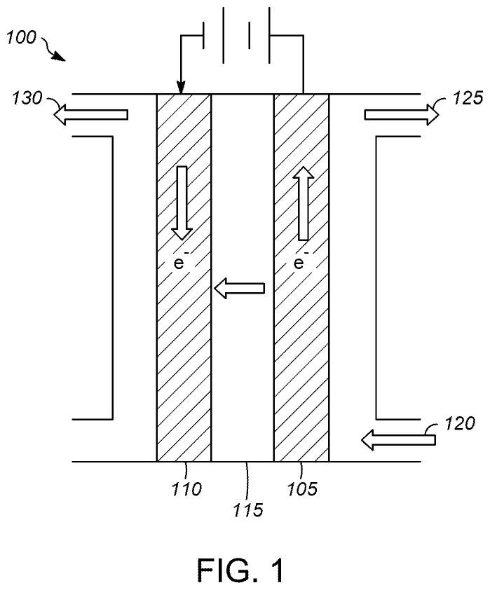

FIG. 2 is an illustration of one embodiment of an AEMWE cell.

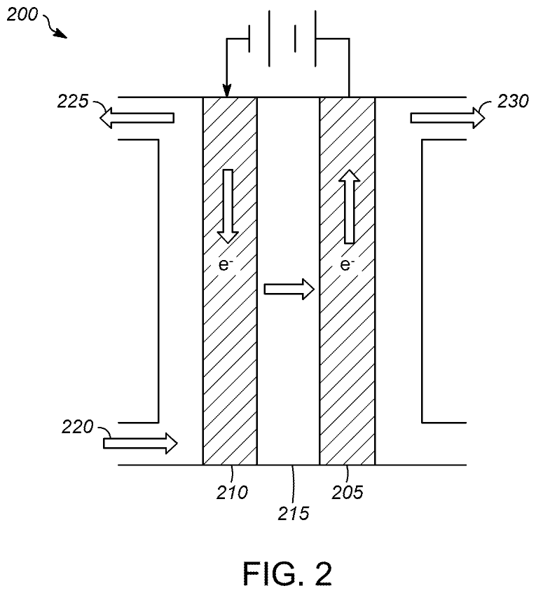

FIG. 3 is an illustration of one embodiment of the synthesis of N-methylpiperidone-d4 deuterated monomer.

FIG. 4 is an illustration of one embodiment of the synthesis of TPMP-AEP-I-d4 deuterated anion exchange polymer.

FIG. 5 is an illustration of one embodiment of the synthesis of TPMP-AEP-OH-d4 deuterated anion exchange polymer.

FIG. 6 is an illustration of one embodiment of the synthesis of TPMP-AEP-HCO₃-d4 deuterated anion exchange polymer.

FIG. 7 is an illustration of one embodiment of the synthesis of TPMP-AEP-OAc-d4 deuterated anion exchange polymer.

FIG. 8 is an illustration of one embodiment of the synthesis of TAMP-AEP-I-d4 deuterated anion exchange polymer.

FIG. 9 is an illustration of one embodiment of the synthesis of TBMP-AEP-I-d8 deuterated anion exchange polymer.

FIG. 10 is an illustration of one embodiment of the synthesis of TBMP-AEP-I-d4 deuterated anion exchange polymer.

### DESCRIPTION OF THE INVENTION

Deuterium, a stable hydrogen isotope, has been playing an important role in polymer science. Deuterated polymers have been studied for about 60 years. The substitution of protium with deuterium in polymers has significantly affected their structures and properties and has provided new functional polymers. For example, Deuterated polymers have been used in organic light emitting diodes (OLEDs) for television monitors and the displays for smartphones, tablets, and other devices. By replacing the labile C—H bonds in the host with C-D bonds for the OLED device, an increase in the device lifetime by a factor of five without a loss of efficiency was achieved.

AEMs prepared from ion exchange polymers comprising positively charged anion exchange functional groups are polymeric electrolytes (also called ionomers) that can conduct anions such as OH⁻ or CO₃²⁻ in an electrochemical reaction system. Different types of quaternary ammonium anion exchange functional groups have been investigated for AEM electrolysis and fuel cell applications. However, most of the commercially available AEMs showed unstable performance towards hydroxide due to different mechanisms of decomposition such as an SN2 reaction mechanism or an E2 mechanism (Hofmann elimination). In an SN2 reaction, the hydroxide anion attacks an electron deficient methylene carbon connected directly to the positively charged anion exchange nitrogen atom. In a Hofmann elimination reaction, the hydroxide abstracts an accessible, relatively acidic proton β to the nitrogen atom. In an AEM electrolysis cell or AEM fuel cell, the hydroxide anions transported through the AEM from the cathode to the anode will attack the positively charged anion exchange functional groups via the reactions mentioned above, which results in the degradation of the anion exchange functional groups and therefore reduces the cell performance. The stability of the AEMs determines the lifetime of the AEM-based electrochemical cell.

The present invention relates to a new type of deuterated anion exchange polymers and anion exchange membranes (AEMs) comprising the deuterated anion exchange polymers. The present invention also relates to new catalyst-coated membranes (CCMs) comprising the deuterated anion exchange polymers, respectively, for electrochemical reactions such as water electrolysis for green H₂ production, CO₂ electrolysis for the production of sustainable hydrocarbons, alcohols, and carbonyl products, or fuel cell applications.

Deuteration resulted in stronger chemical bonds C-D bonds and stronger van der Waals interactions in the present deuterated anion exchange polymers. Therefore, the stability of the deuterated polymers in the present invention against thermal, oxidative, reductive, and corrosive conditions can be significantly higher than that of its protiated counterpart because the primary polymer degradation process in the AEM-based electrochemical processes involves breaking C—H bonds such as Hofmann elimination.

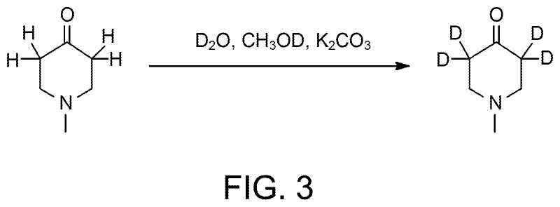

FIG. 3 is one example of the synthesis of a new deuterated monomer N-methylpiperidone-d4 that can be used for the synthesis of novel deuterated anion exchange polymers for the preparation of stable AEM for AEM water electrolysis, AEM fuel cell, or AEM CO₂ electrolysis.

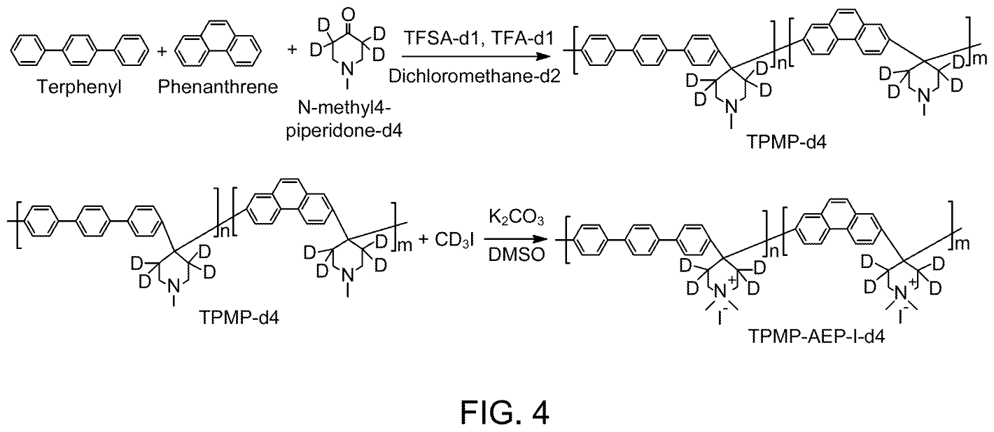

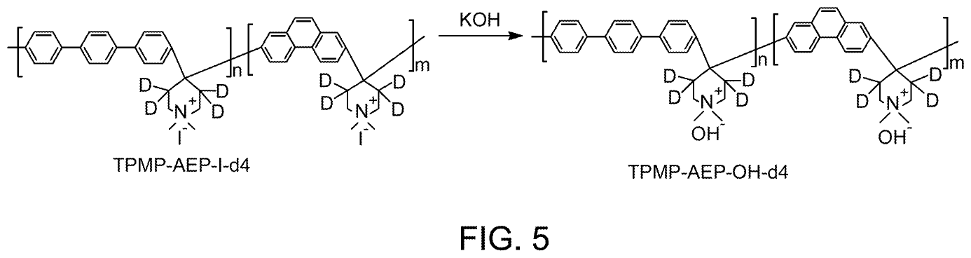

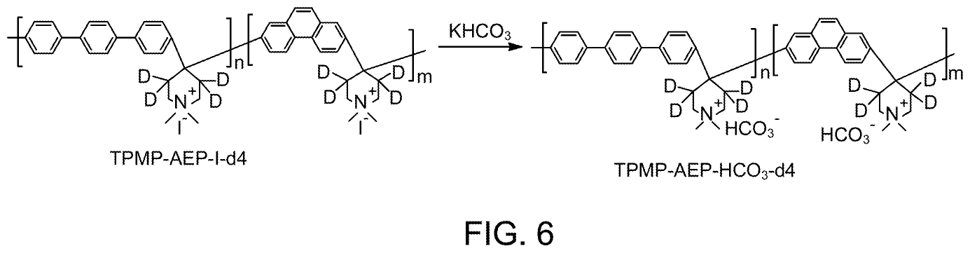

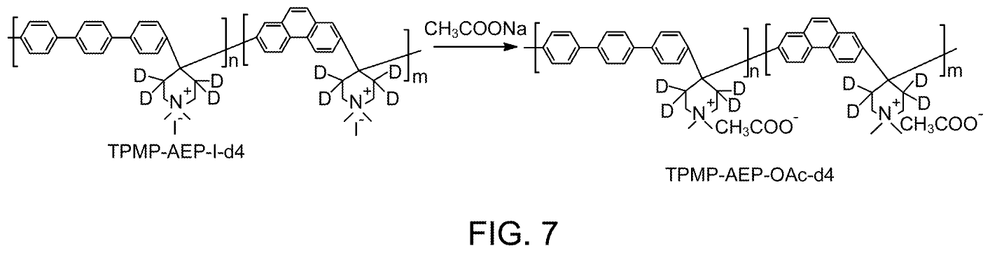

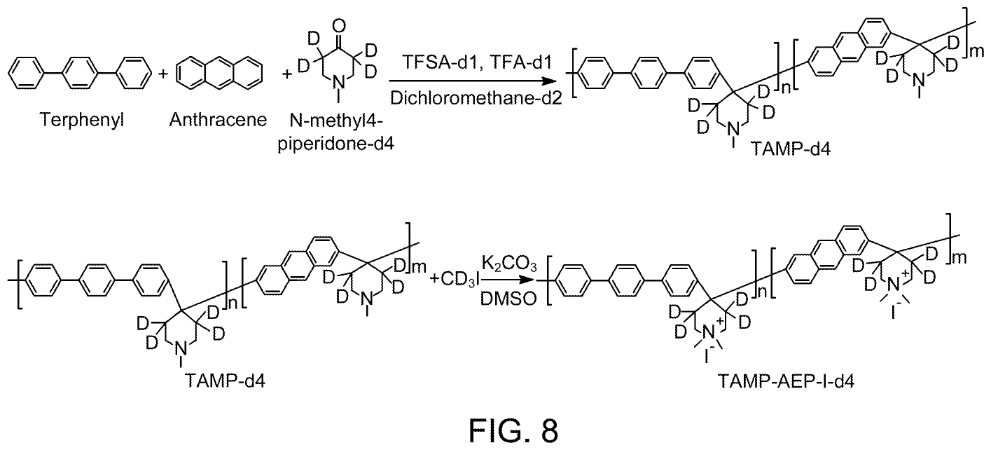

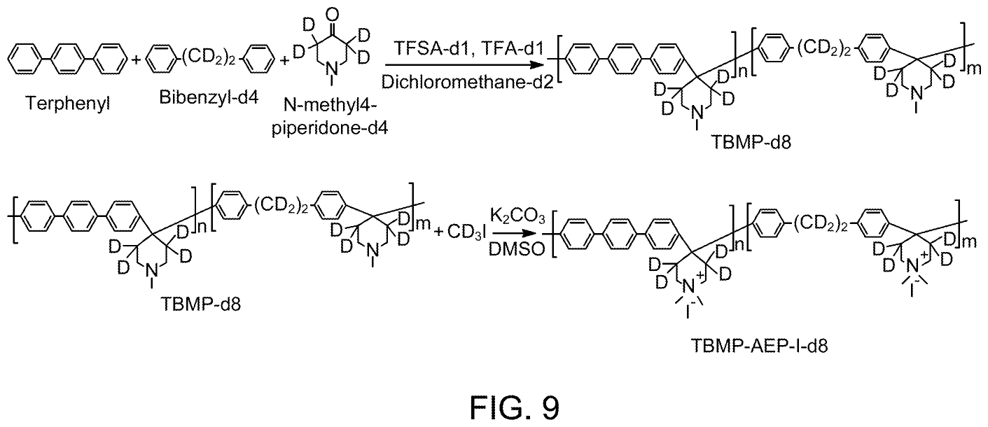

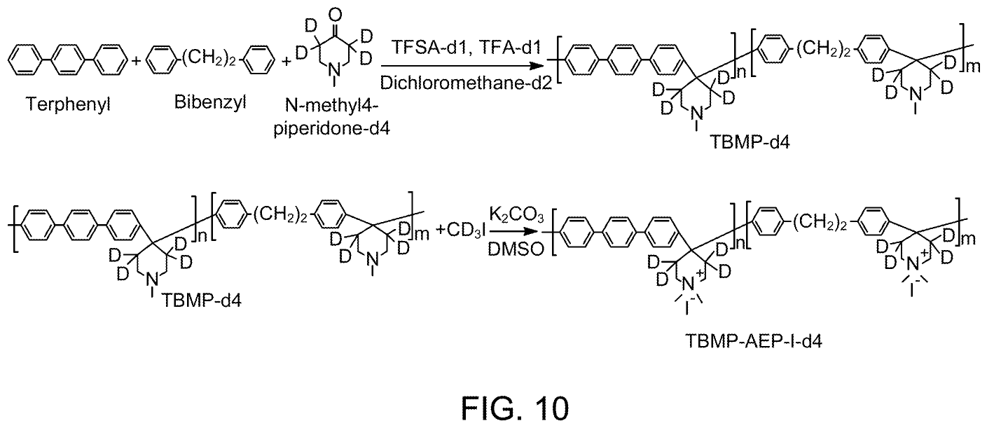

FIG. 4 to FIG. 10 are examples of the synthesis of novel deuterated anion exchange polymers from deuterated monomer N-methylpiperidone-d4 for the preparation of stable AEM for AEM water electrolysis, AEM fuel cell, or AEM CO₂ electrolysis.

Novel deuterated anion exchange polymers comprising a plurality of repeating units of formula (I)

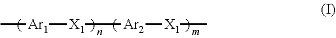

have been developed for the preparation of AEMs. The deuterated anion exchange polymers have stable hydrophobic polymer backbones and stable hydrophilic quaternary ammonium cationic groups on the polymer side chains. Cationic groups, like piperidinium, quaternized carbazole derivative, quaternized phenothiazine derivative, or piperidinium salt, were covalently incorporated into the polymers for the preparation of novel AEMs. Deuteration of X₁ or deuteration of both X₁ and Ar₂ resulted in stronger C-D bonds and stronger van der Waals interactions in the present deuterated anion exchange polymers. Therefore, these polymers provide high OH⁻ conductivity, high chemical and thermal stability, low swelling in alkaline water at about 60-120° C., and high mechanical stability. The deuterated anion exchange polymers can be used for electrolysis, such as water or CO₂ electrolysis, as well as other uses such as redox flow batteries, and fuel cell applications.

The deuterated anion exchange polymers were designed to: enhance chemical and thermal stability by incorporating deuterated X₁ or both deuterated X₁ and deuterated Ar₂ into the anion exchange polymers comprising a plurality of repeating units of formula (I) and a polymer backbone free of ether bonds, enhance OH⁻ conductivity by incorporating a quaternized carbazole derivative, or a quaternized phenothiazine derivative, or both into the polymer side chain comprising piperidinium or a piperidinium salt; and increase polymer backbone rigidity and molecular weight to enhance the mechanical strength of the polymer. The polymers have deuterated hydrophilic polymer side chains, stable hydrophilic quaternary ammonium cationic groups, such as quaternized carbazole derivative, piperidinium ion-conducting functional groups, or quaternized phenothiazine derivative. The deuterated anion exchange polymers enable efficient and stable operation in water or CO₂ electrolysis, redox flow battery, and fuel cell applications.

One aspect of the invention is a deuterated anion exchange polymer. In one embodiment, the polymer comprises a plurality of repeating units of formula (I)

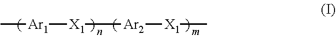

wherein Ar₁ is selected from the group consisting of:

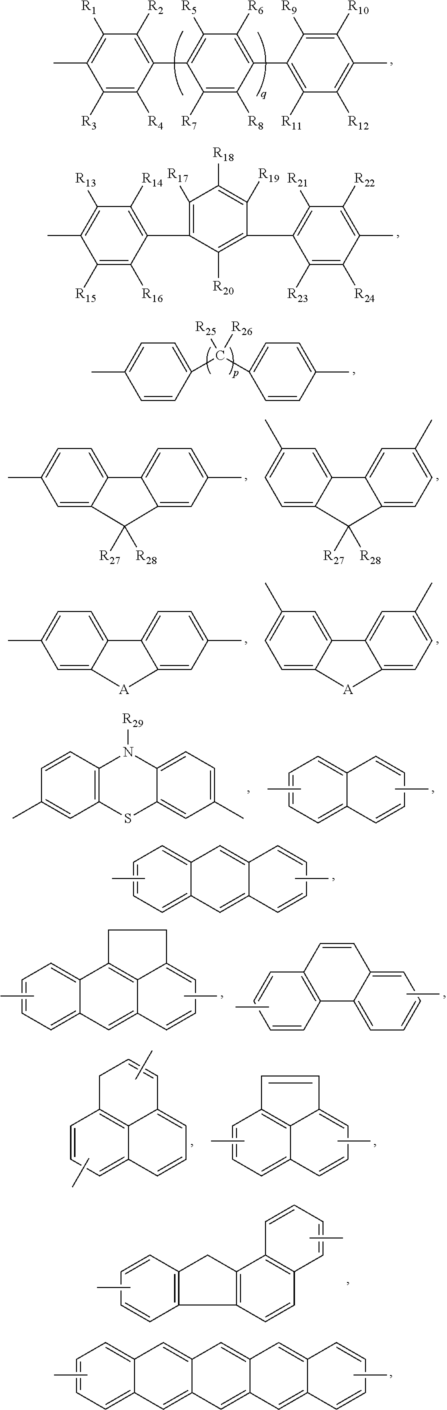

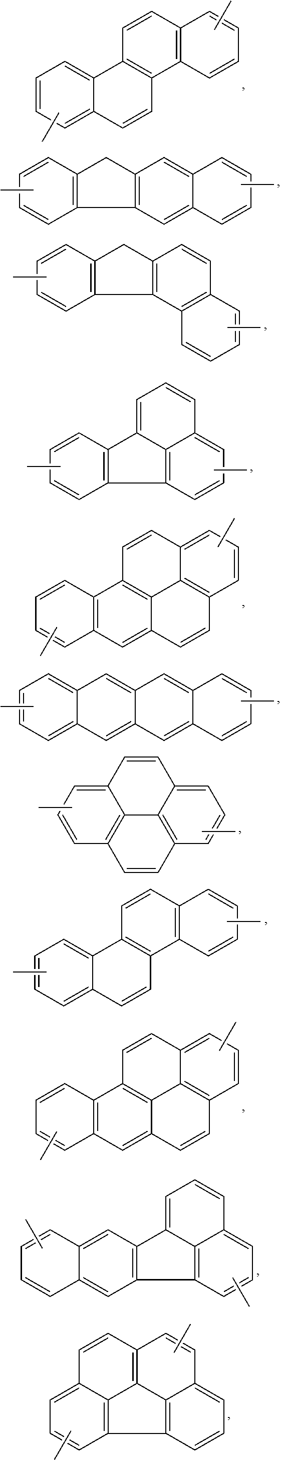

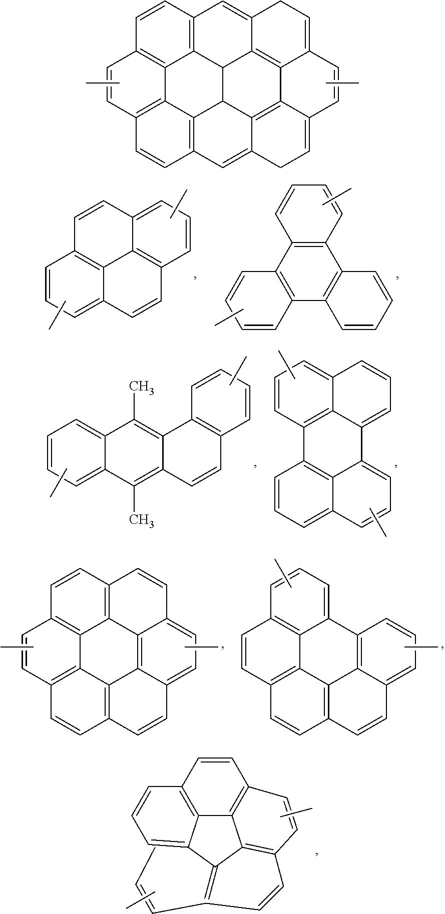

and mixtures thereof;
Ar₂ is selected from the group consisting of:

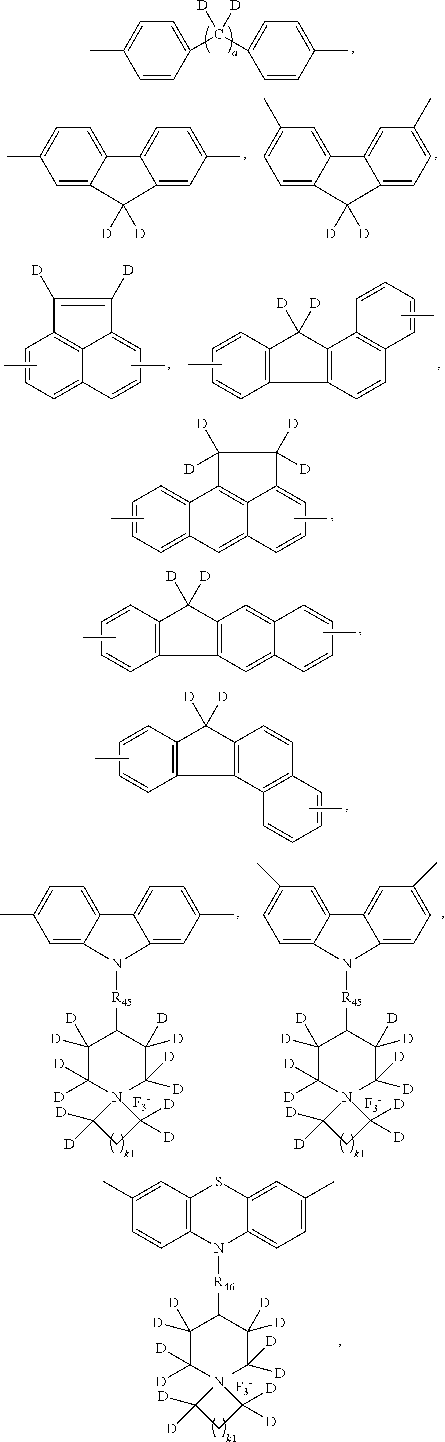

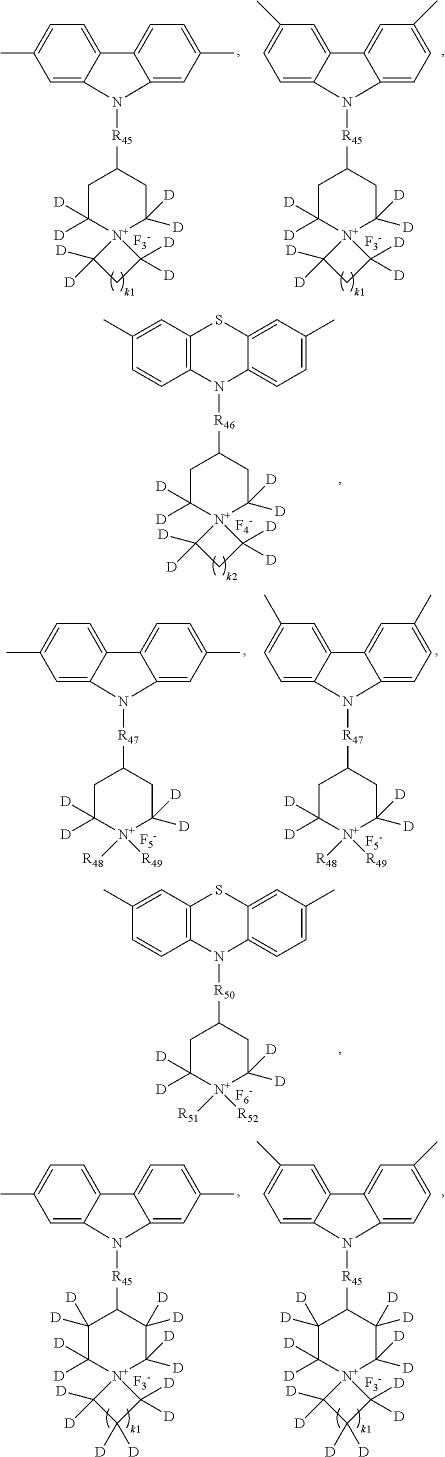

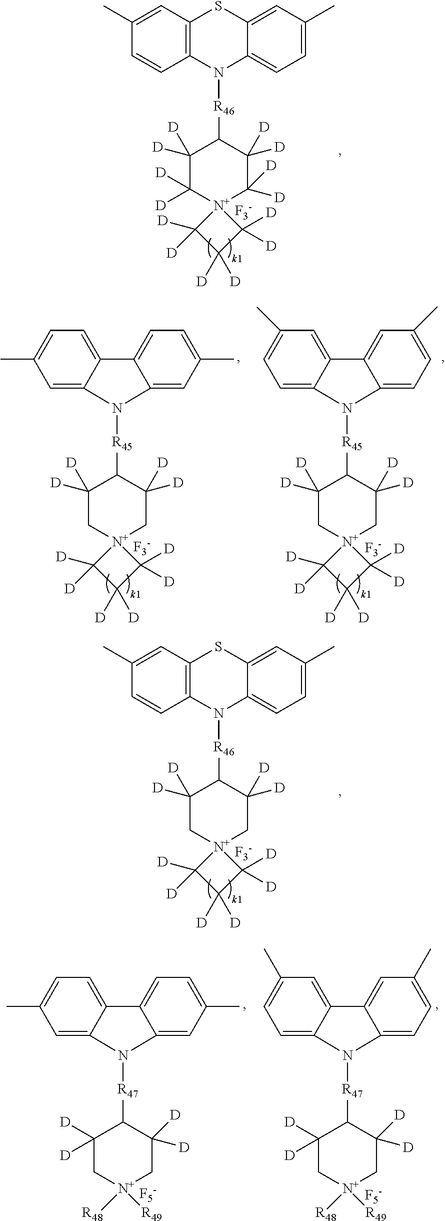

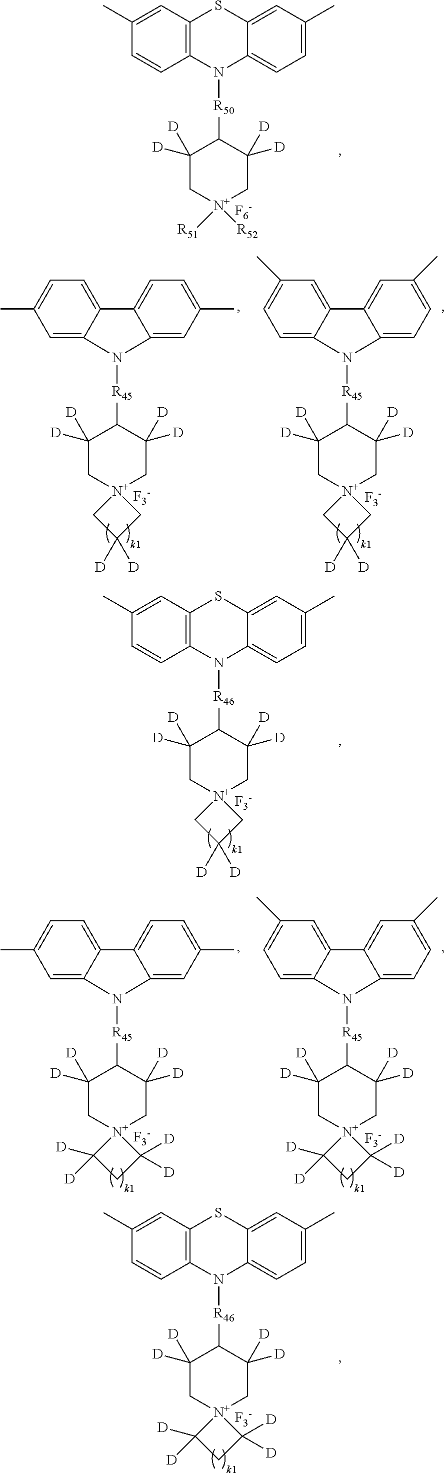

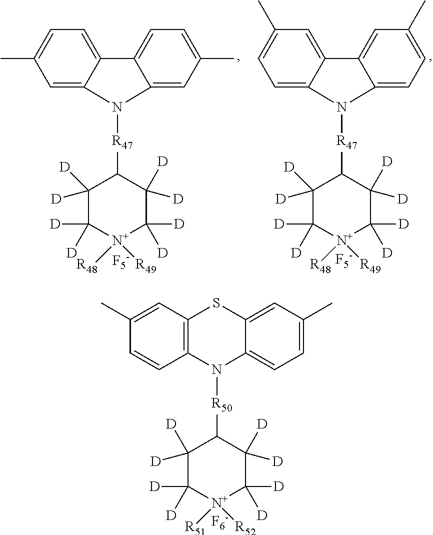

and mixtures thereof;
X₁ is selected from the group consisting of:

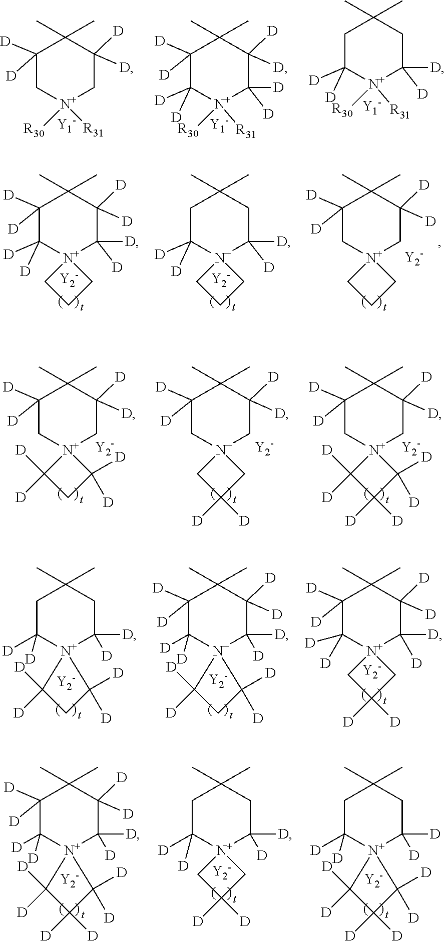

optionally

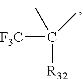

and mixtures thereof;
wherein F₃⁻-F₆⁻, Y₁⁻ and Y₂⁻ are each independently anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉ is hydrogen, an alkyl group, an alkenyl group, an alkynyl group, or an aryl group, and the alkyl, alkenyl, alkynyl or aryl groups are optionally substituted with a halide or a positively charged functional group;
wherein R₃₀-R₃₂ are each independently an alkyl group, an alkenyl group, an alkynyl group, or an aryl group, and the alkyl, alkenyl, alkynyl or aryl group is optionally substituted with a halide or a positively charged functional group;
wherein R₄₅-R₅₂ are each independently an alkyl group, an alkenyl group, an aryl group, or combinations thereof;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 5 to 1,000, m is an integer from 0 to 1,000, and the molar ratio of n/m is in a range of 1:0 to 1:50;
wherein p is 1, 2, 3, or 4;
wherein q is 0, 1, 2, or 3; and
wherein a, k₁, k₂, t are independently 1, 2, 3, 4, 5, or 6.

In some embodiments, Ar₁ is selected from the group consisting of

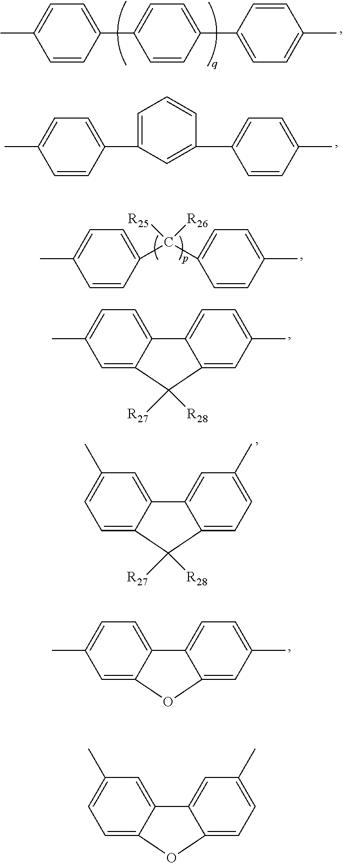

and mixtures thereof,
wherein R₂₅, R₂₆, R₂₇, and R₂₈ are each independently —H or —CH₃;
wherein p is 1 or 2; and
wherein q is 0 or 1.

In some embodiments, Ar₁ is selected from the group consisting of

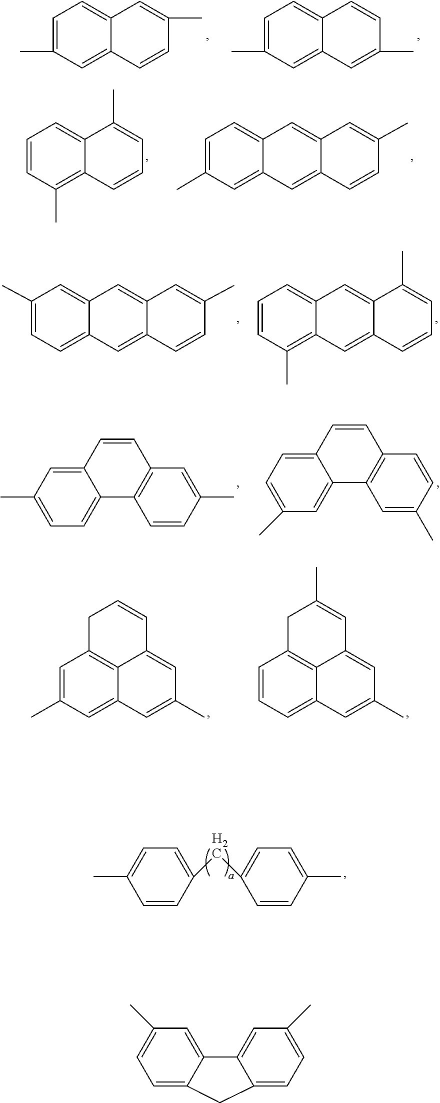

or mixtures thereof,
wherein a is 1 or 2.

In some embodiments, Ar₁ is selected from the group consisting of

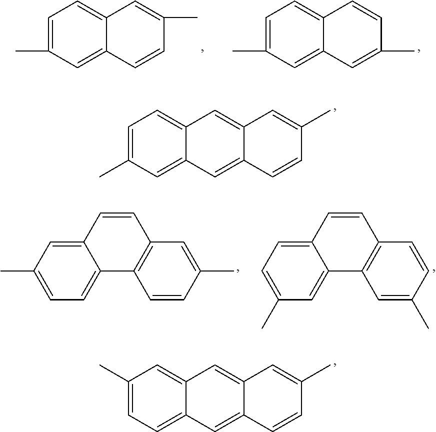

and mixtures thereof.

In some embodiments, Ar₂ is selected from the group consisting of

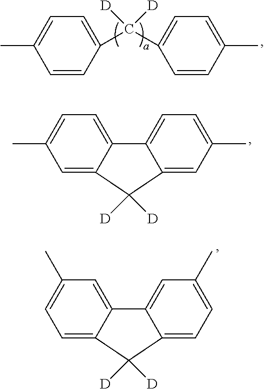

and mixtures thereof,
wherein a is 1 or 2.

In some embodiments, X₁ is

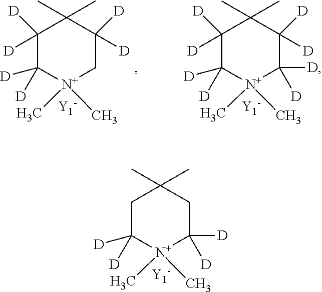

or mixtures thereof; and
wherein Y₁⁻ is OH⁻, HCO₃⁻, CH₃COO⁻, CF₃COO⁻, or I⁻.

In some embodiments, X₁ is

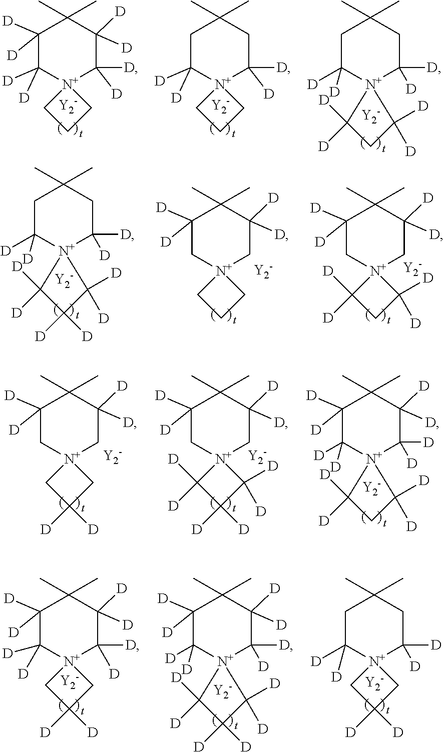

or mixtures thereof,
wherein t is 3; and
wherein Y₂⁻ is HCO₃⁻, CH₃COO⁻, CF₃COO⁻, OH⁻ or I⁻.

In some embodiments, X₁ is a mixture of

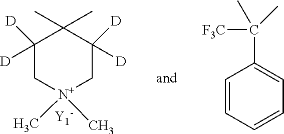

wherein Y₁⁻ is OH⁻, HCO₃⁻, CH₃COO⁻, CF₃COO⁻, or I⁻.

In some embodiments, X₁ is a mixture of

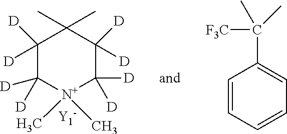

wherein Y₁⁻ is OH⁻, HCO₃⁻, CH₃COO⁻, CF₃COO⁻, or I⁻.

In some embodiments, X₁ is a mixture of

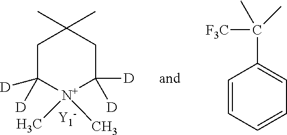

wherein Y₁⁻ is OH⁻, HCO₃⁻, CH₃COO⁻, CF₃COO⁻, or I⁻.

The deuterated anion exchange polymer comprising a plurality of repeating units of formula (I) may be synthesized by two steps: 1) a superacid or deuterated superacid catalyzed polyhydroxyalkylation reaction of monomers Ar₁′ and Ar₂′ with deuterated monomer X₁′ to form a neutral precursor polymer; and 2) a Menshutkin reaction to convert the neutral precursor polymer with functional groups, such as piperidine-based groups, to the anion exchange polymer comprising a plurality of repeating units of formula (I) with anion-conducting functional groups, such as piperidinium-based cation groups; wherein Ar₁′ is selected from the group consisting of:

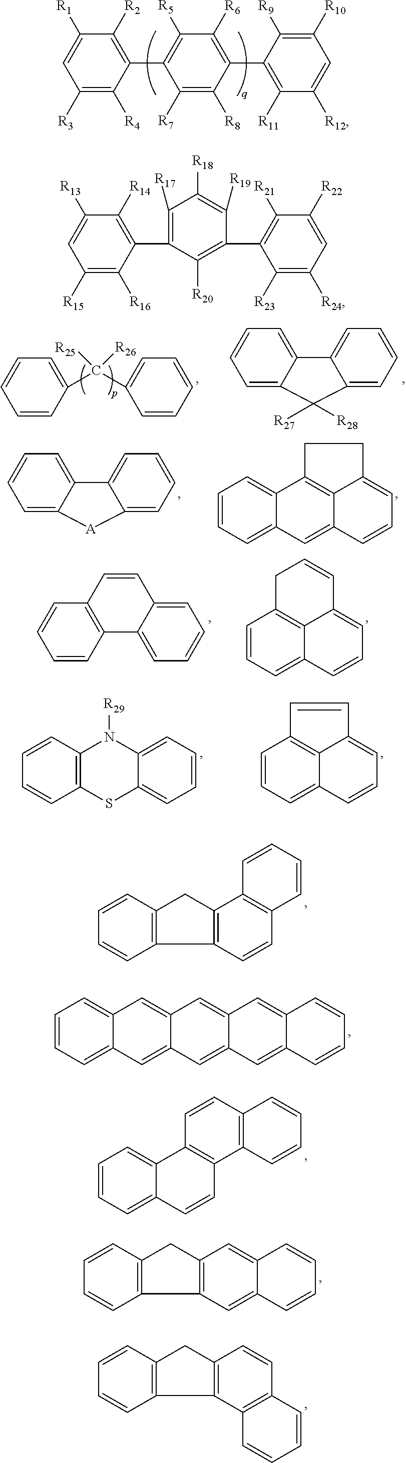

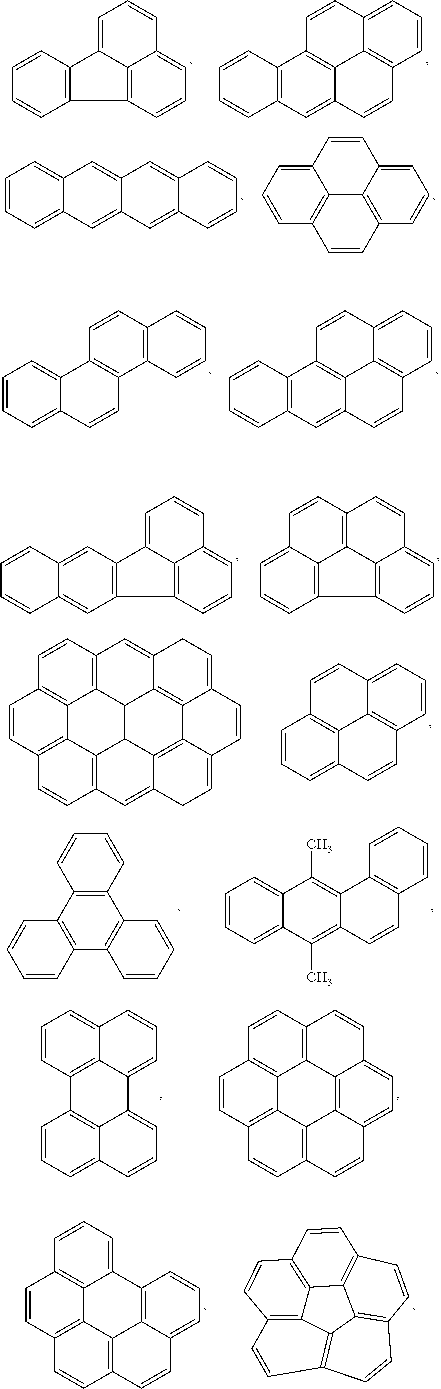

and mixtures thereof;
Ar₂′ is selected from the group consisting of:

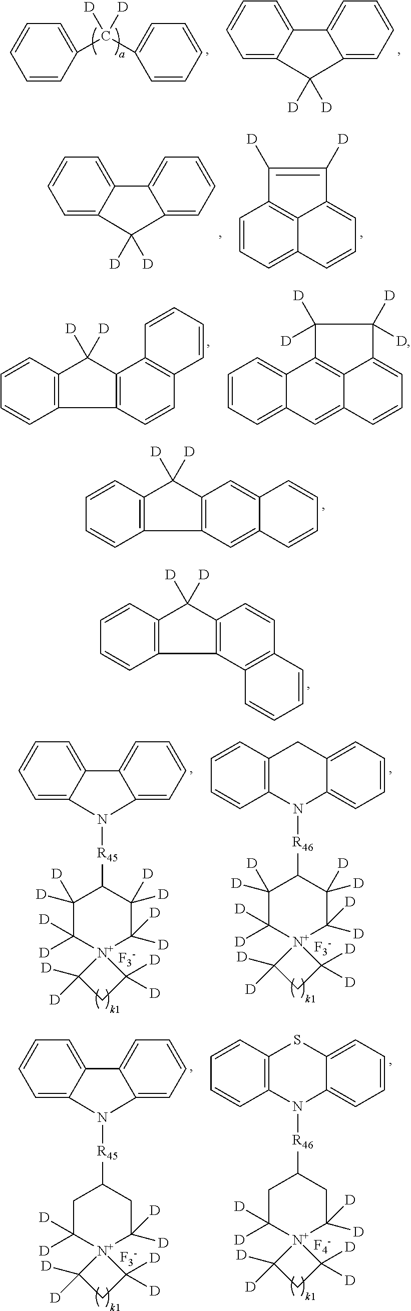

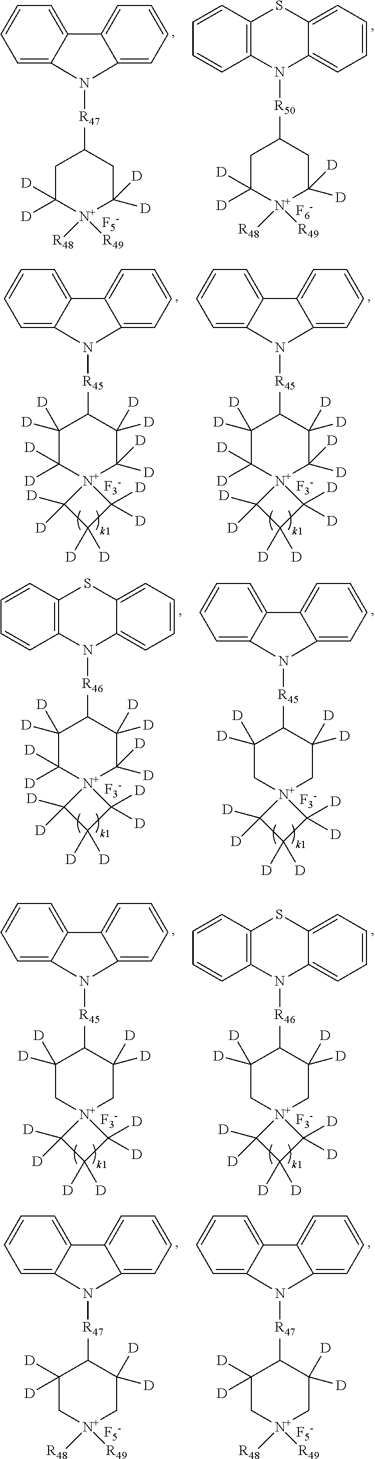

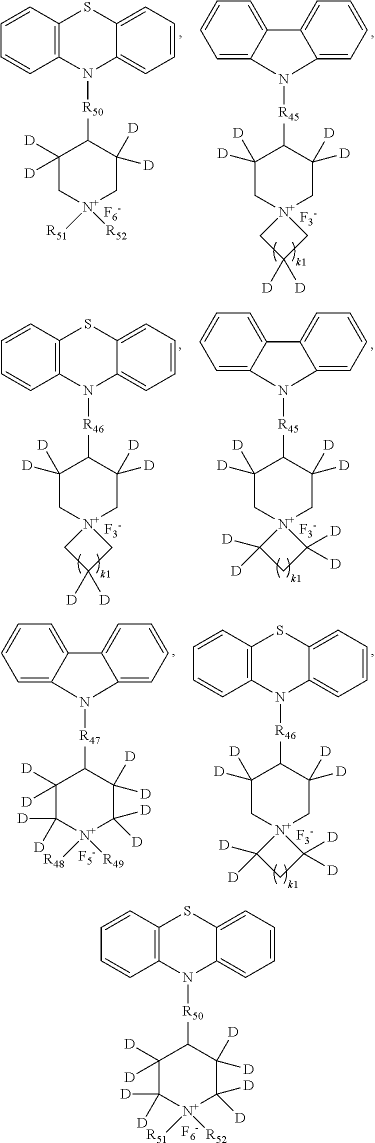

and mixtures thereof; and
X₁′ is selected from the group consisting of:

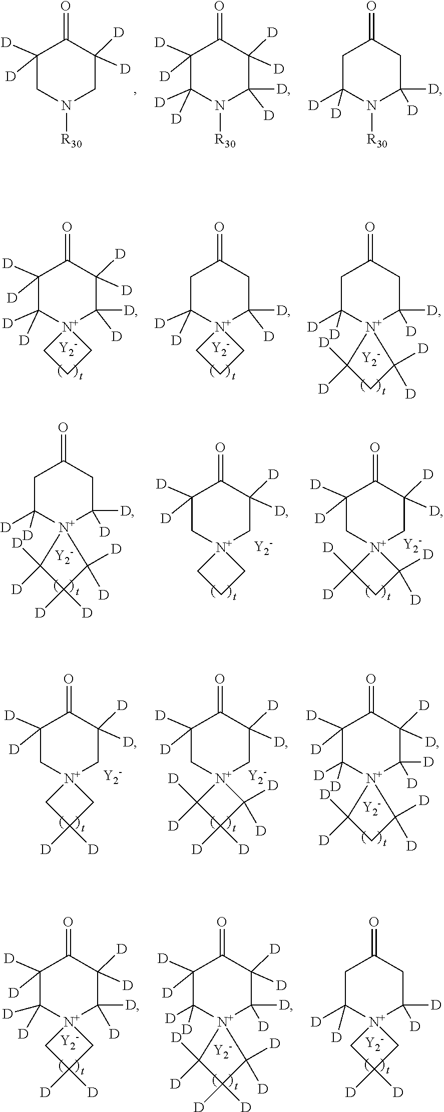

optionally

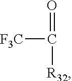

and mixtures thereof;
wherein F₃⁻-F₆⁻, Y₂⁻ are independently anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉-R₃₀ is are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein R₄₅-R₅₂ are each independently an alkyl group, an alkenyl group, an aryl group, or combinations thereof;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 5 to 1,000, m is an integer from 0 to 1,000, and the molar ratio of n/m is in a range of 1:0 to 1:50;
wherein p is 1, 2, 3, or 4;
wherein q is 0, 1, 2, or 3; and
wherein a, k₁, k₂, t are independently 1, 2, 3, 4, 5, or 6.

In some embodiments, the deuterated anion exchange polymer comprising a plurality of repeating units of formula (I) has no Ar₂ and may be synthesized by two steps: 1) a superacid or deuterated superacid catalyzed polyhydroxyalkylation reaction of monomers Ar₁′ such as a mixture of p-terphenyl and phenanthrene with deuterated monomer X₁′ such as N-methyl-4-piperidone-d4 to form a neutral precursor polymer; and 2) a Menshutkin reaction to convert the neutral precursor polymer with functional groups, such as piperidine-based groups, to the anion exchange polymer comprising a plurality of repeating units of formula (I) with anion-conducting functional groups, such as piperidinium-based cation groups.

Optionally, the deuterated anion exchange polymer comprising a plurality of repeating units of formula (I) with anion-conducting functional groups, such as piperidinium-based cation groups, quaternized carbazole derivative cation groups, and negatively charged halide, bicarbonate, or acetate ions is converted to a deuterated anion exchange polymer comprising a plurality of repeating units of formula (I) with anion-conducting functional groups, such as piperidinium-based cation groups, quaternized carbazole derivative cation groups, and negatively charged OH⁻ ions by soaking in a base solution before the polymer is made into a membrane.

The polyhydroxyalkylation reaction of monomer Ar₁′ and deuterated monomer Ar₂′ with deuterated monomer X₁′ provides a deuterated anion exchange polymer with a polymer backbone free of ether bonds, which results in high chemical stability of the polymer. The incorporation of deuterated X₁′ monomer or deuterated X₁′ and Ar₂′ monomers resulted in stronger C-D bonds and stronger van der Waals interactions in the present deuterated anion exchange polymers which helps achieve stable high OH⁻ conductivity. In some cases, the monomer X₁′ is a mixture of a deuterated piperidone-based monomer and a non-piperidone-based monomer to enable the formation of a high molecular weight deuterated anion exchange polymer. The combination of the hydrophobic polymer backbone, the hydrophilic polymer side chains, and deuterated monomer provides the novel deuterated anion exchange polymer with high OH⁻ conductivity, high chemical and thermal stability, high mechanical strength, and long-term performance stability. The molar ratio of Ar₁′ monomer to Ar₂′ monomer can be in a range of 1:0 to 1:50, or in a range of 1:0 to 1:10, or in a range of 20:1 to 1:5. The molar ratio of X1′ monomer to the total of Ar₁′ and Ar₂′ monomers can be in a range of 1.2:1 to 1:1.2, or in a range of 1.1:1 to 1:1.1, or in a range of 1.05:1 to 1:1.05.

The superacid catalyzed polyhydroxyalkylation reaction can be carried out at −10° C. to 50° C., or at −5° C. to 30° C., or at −5° C. to 25° C. for 2 h to 72 h, or 10 h to 48 h, or 12 to 24 h. Suitable superacid catalysts include, but are not limited to, trifluoromethanesulfonic acid (CF₃SO₃H (TFSA)), deuterated trifluoromethanesulfonic acid (CF₃SO₃D (TFSA-d1)), methanesulfonic acid (MSA), deuterated methanesulfonic acid (MSA-d1), fluorosulfuric acid (FSO₃H), deuterated fluorosulfuric acid (FSO₃D), or mixtures thereof. Solvents for the polyhydroxyalkylation reaction are those that can dissolve one or more of the monomers. Suitable solvents include, but are not limited to, methylene chloride, deuterated methylene chloride, chloroform, deuterated chloroform, trifluoroacetic acid (TFA), deuterated trifluoroacetic acid (TFA-d1), or mixtures thereof.

The Menshutkin reaction is used to react the neutral precursor polymer with an alkyl halide, or with a trialkyl amine first followed by an alkyl halide to convert the neutral precursor polymer to the deuterated anion exchange polymer comprising a plurality of repeating units of formula (I). Suitable alkyl halides include, but are not limited to, alkyl iodides, deuterated alkyl iodides, alkyl bromides, or deuterated alkyl bromides. Suitable alkyl amines include, but are not limited to, trimethyl amine or triethyl amine. The Menshutkin reaction can be carried out at 10° C. to 80° C., or at 20° C. to 30° C. for 2 h to 72 h, or 10 h to 48 h, or 12 to 24 h. Solvents for the Menshutkin reaction are those that can dissolve the neutral precursor polymer. Suitable solvents include, but are not limited to, N-methylpyrrolidone (NMP), N,N-dimethyl acetamide (DMAC), N,N-dimethylformamide (DMF), dimethyl sulfoxide (DMSO), 1,3-dioxolane, deuterated solvents thereof, or mixtures thereof.

The deuterated anion exchange polymer comprising a plurality of repeating units of formula (I) has a weight average molecular weight in a range of 10,000 to 1,000,000 Daltons, or in a range of 50,000 to 500,000 Daltons.

Another aspect of the invention is a deuterated anion exchange membrane comprising the polymer described above. The deuterated anion exchange membrane may be used in a wide variety of applications including, but not limited to, fuel cells, electrolyzers, flow batteries, electrodialyzers, waste metal recovery systems, electrocatalytic hydrogen production systems, desalinators, water purifiers, waste water treatment systems, ion exchangers, or CO₂ separators.

In some embodiments, the deuterated anion exchange membrane comprises a nonporous symmetric dense film membrane, an integrally-skinned asymmetric membrane, a reinforced composite membrane, or a thin film composite membrane. By “dense” we mean that the membrane does not have pores larger than 1 nm.

In some embodiments, the reinforced composite membrane or the thin film composite membrane comprises a porous substrate membrane impregnated or coated with the ion exchange polymer. The porous substrate membrane is prepared from a polymer different from the ion exchange polymer.

In some embodiments, the nonporous symmetric dense film membrane, the integrally-skinned asymmetric membrane, the reinforced composite membrane, or the thin film composite membrane may be a flat sheet membrane.

In some embodiments, the nonporous symmetric dense film deuterated anion exchange membrane is prepared using a method comprising: 1) dissolving the deuterated anion exchange polymer in a solvent to form a polymer casting solution; 2) casting the polymer casting solution on a nonporous substrate to form a uniform layer of the polymer casting solution; 3) drying the polymer casting solution layer to form a dried membrane on the nonporous substrate at 50° C. to 180° C., or at 50° C. to 120° C., or at 80° C. to 120° C.; and optionally 4) ion exchanging the halide anions of the deuterated anion exchange polymer in the membrane with hydroxide, bicarbonate, acetate, carbonate ions, or a combination thereof to form the nonporous symmetric dense film deuterated anion exchange polymer membrane. The nonporous substrate is removed from the membrane when the membrane is used in a desired application. The solvent used to dissolve the anion exchange polymer can be selected from, but is not limited to, NMP, DMAc, DMF, DMSO, 1,3-dioxolane, or mixtures thereof. The nonporous substrate used for the fabrication of the nonporous symmetric dense film membrane can be selected from, but is not limited to, glass plate, polyolefin film, polyester film, or fluorocarbon-based polymer film such as poly(tetrafluoroethylene) (PTFE) and poly(vinylidene fluoride) (PVDF) film.

In some embodiments, the integrally-skinned asymmetric deuterated anion exchange membrane is prepared using a method comprising: 1) making a deuterated anion exchange polymer membrane casting solution comprising the deuterated anion exchange polymer with formula (I), solvents which are miscible with water and can dissolve the deuterated anion exchange polymer, and non-solvents which cannot dissolve the deuterated anion exchange polymer; 2) casting a layer of the deuterated anion exchange polymer membrane casting solution onto a supporting substrate; 3) evaporating the solvent and non-solvent from the surface of the coated layer and then coagulating the coated polymer layer in a coagulating bath to form the integrally-skinned asymmetric membrane structure; 5) drying the membrane at 50° C. to 150° C., or at 50° C. to 120° C., or at 80° C. to 120° C.; and optionally 6) ion exchanging the halide anions of the deuterated anion exchange polymer in the membrane with hydroxide, bicarbonate, acetate, carbonate ions, or a combination thereof to form the integrally-skinned asymmetric deuterated anion exchange polymer membrane. In some embodiments, the supporting substrate is removed from the membrane when the membrane is used in a desired application. In some embodiments, the supporting substrate is part of the final integrally-skinned asymmetric deuterated anion exchange polymer membrane. The supporting substrate may comprise polyolefin such as polypropylene and polyethylene, polyester, polyamide such as Nylon 6 and Nylon 6,6, cellulose, or fluorocarbon-based polymer such as PTFE and PVDF. The solvents for the preparation of the integrally-skinned asymmetric membrane include, but are not limited to, NMP, DMAc, DMF, DMSO, dioxanes, 1,3-dioxolane, and mixtures thereof. The non-solvents for the preparation of the integrally-skinned asymmetric membrane include, but are not limited to, acetone, methanol, ethanol, tetrahydrofuran (THF), toluene, n-octane, n-decane, lactic acid, citric acid, isopropanol, and mixtures thereof. The integrally-skinned asymmetric membrane may have a thin nonporous dense layer less than 500 nm on a microporous support layer.

In some embodiments, the reinforced composite deuterated anion exchange membrane is prepared using a method comprising: 1) dissolving the deuterated anion exchange polymer in a solvent to form a polymer solution; 2) impregnating a porous matrix support membrane with the deuterated anion exchange polymer solution to fill the pores with the deuterated anion exchange polymer via dip-coating, soaking, spraying, painting, or other known conventional solution impregnating method; 3) drying the impregnated membrane at 50° C. to 150° C., or at 50° C. to 120° C., or at 80° C. to 120° C.; and optionally 4) ion exchanging the halide anions of the deuterated anion exchange polymer in the pores of the reinforced membrane with hydroxide, bicarbonate, acetate, carbonate ions, or a combination thereof to form the reinforced composite deuterated anion exchange membrane with interconnected anion exchange polymer domains in a porous matrix. The solvents for the preparation of the thin film composite deuterated anion exchange membrane include, but are not limited to, NMP, DMAc, DMF, DMSO, dioxanes, 1,3-dioxolane, and mixtures thereof. The porous matrix should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The porous matrix must be compatible with the electrochemical cell chemistry and meet the mechanical demands of cell stacking or winding assembly operations.

The polymers suitable for the preparation of the porous matrix can be selected from, but not limited to, polyolefins such as polyethylene and polypropylene, polyamide such as Nylon 6 and Nylon 6,6, polyester, cellulose acetate, polybenzimidazole, fluorocarbon-based polymer such as PTFE and PVDF, polycarbonate, cellulose, or combinations thereof. These polymers provide a range of properties such as low cost, high stability in alkaline water, good mechanical stability, and ease of processability for porous matrix fabrication.

The porous matrix can either a non-woven matrix or a woven matrix and have either a symmetric porous structure or an asymmetric porous structure. The porous matrix can be formed by an electrospinning process, a phase inversion membrane fabrication approach followed by direct air drying, or by phase inversion followed by solvent exchange methods. The porous matrix also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the pores. The wet processing of polyolefin porous matrix is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the porous matrix can be in a range of 10-400 micrometers, or a range of 10-200 micrometers, or a range of 10-100 micrometers, or a range of 20-100 micrometers. The pore size of the porous matrix can be in a range of 1 micrometer to 500 micrometers, or a range of 10 micrometer to 200 micrometers, or a range of 50 micrometers to 100 micrometer.

In some embodiments, the thin film composite deuterated anion exchange membrane is prepared using a method comprising: 1) dissolving the deuterated anion exchange polymer in a solvent to form a polymer coating solution; 2) coating a layer of the deuterated anion exchange polymer coating solution on one surface of a microporous support membrane via dip-coating, meniscus coating, spin coating, casting, soaking, spraying, painting, or other known conventional solution coating technologies; 3) drying the coated membrane at 50° C. to 150° C., or at 50° C. to 120° C., or at 80° C. to 120° C.; and optionally 4) ion exchanging the halide anions of the deuterated anion exchange polymer in the coating layer with hydroxide, bicarbonate, acetate, carbonate ions, or a combination thereof to form the thin film composite deuterated anion exchange membrane. The solvents for the preparation of the thin film composite deuterated anion exchange membrane include, but are not limited to, NMP, DMAc, DMF, DMSO, dioxanes, 1,3-dioxolane, and mixtures thereof. The microporous support membrane should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The microporous support membrane must be compatible with the electrochemical cell chemistry and meet the mechanical demands of cell stacking or winding assembly operations.

The polymers suitable for the preparation of the microporous support membrane can be selected from, but not limited to, polyolefins such as polyethylene and polypropylene, polyamide such as Nylon 6 and Nylon 6,6, polyester, cellulose acetate, polybenzimidazole, fluorocarbon-based polymer such as PTFE and PVDF, polycarbonate, cellulose, or combinations thereof. These polymers provide a range of properties such as low cost, high stability in alkaline water, good mechanical stability, and ease of processability for membrane fabrication.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-400 micrometers, or a range of 10-200 micrometers, or a range of 10-100 micrometers, or a range of 20-100 micrometers. The pore size of the microporous membrane can be in a range of 10 nanometers to 50 micrometers, or a range of 50 nanometers to 10 micrometers, or a range of 0.2 micrometers to 1 micrometer.

Another aspect of the invention is a membrane electrode assembly. In one embodiment, the membrane electrode assembly comprises: a deuterated anion exchange membrane comprising the deuterated anion exchange polymer described above; an anode comprising an anode catalyst on a first surface of the deuterated ion exchange membrane; and a cathode comprising a cathode catalyst on a second surface of the deuterated anion exchange membrane; and

In some embodiments, the membrane electrode assembly further comprises: an anode porous transport layer adjacent to the anode; and a cathode porous transport layer adjacent to the cathode. In some embodiments, the anode and the cathode catalysts are platinum group metal (PGM)-free electrocatalysts. The anode and the cathode catalysts are for oxygen evolution reaction and hydrogen evolution reaction, respectively. The anode and the cathode catalysts should have low cost, good electrical conductivity, and good electrocatalytic activity and stability. Suitable cathode catalysts can be selected from, but are not limited to, Ni-based alloys such as Ni—Mo, Ni—Al, Ni—Cr, Ni—Sn, Ni—Co, Ni—W, and Ni—Al—Mo, metal carbides such as Mo₂C, metal phosphides such as CoP, metal dichalcogenides such as MoSe₂, and mixtures thereof. Suitable anode catalysts can be selected from, but are not limited to, Ni—Fe alloy, Ni—Mo alloy, spinel CuₓCo₃ₓO₃, Ni—Fe layered double hydroxide nanoplates on carbon nanotubes, immobilized metal catalyst on conductive supports, and mixtures thereof.

In some embodiments, the anode comprising an anode catalyst on a first surface of the deuterated anion exchange membrane is formed by coating an anode catalyst ink on the first surface of the deuterated anion exchange membrane via meniscus coating, knife coating, spray coating, painting, or other known conventional ink coating technologies, followed by drying the coated deuterated anion exchange membrane.

In some embodiments, the cathode comprising a cathode catalyst on a second surface of the deuterated anion exchange membrane is formed by coating a cathode catalyst ink on the second surface of the deuterated anion exchange membrane via meniscus coating, knife coating, spray coating, painting, or other known conventional ink coating technologies, followed by drying the deuterated coated anion exchange membrane.

In some embodiments, the anode catalyst ink comprises the anode catalyst, an OH⁻ exchange ionomer selected from the deuterated anion exchange polymer in the present invention as a binder, and a solvent. In some embodiments, the cathode catalyst ink comprises the cathode catalyst, an OH⁻ exchange ionomer selected from the deuterated anion exchange polymer in the present invention as a binder, and a solvent. The OH⁻ exchange ionomer selected from the deuterated anion exchange polymer in the present invention binder creates OH⁻ transport pathways between the membrane and the reaction sites within the electrodes and thus drastically improves the utilization of the electrocatalyst particles while reducing the internal resistance. The OH⁻ exchange ionomer binder can have a chemical structure similar to the deuterated anion exchange polymer described above, so that the binder will allow low interfacial resistance and similar expansion in contact with water to avoid catalyst delamination, but OH⁻ conductivity and high oxygen and hydrogen permeance. The solvent can be selected from, but is not limited to, water, alcohol, or a mixture thereof.

The anode porous transport layer and the cathode porous transport layer simultaneously transport electrons, heat, and products with minimum voltage, current, thermal, interfacial, and fluidic losses. The cathode porous transport layer can be made from, but is not limited to, stainless steel, titanium meshes, titanium felts, titanium foams, or carbon-based materials such as non-woven carbon paper, non-woven carbon cloth, or woven carbon cloth. The anode porous transport layer can be made from, but is not limited to, stainless steel, titanium meshes, titanium felts, or titanium foams.

### SPECIFIC EMBODIMENTS

While the following is described in conjunction with specific embodiments, it will be understood that this description is intended to illustrate and not limit the scope of the preceding description and the appended claims.

A first embodiment of the invention is a deuterated anion exchange polymer for electrochemical reactions. An embodiment of the invention is one, any or all of prior embodiments in this paragraph up through the first embodiment in this paragraph wherein the electrochemical reactions comprise water electrolysis, CO₂ electrolysis, fuel cell, and flow battery. An embodiment of the invention is one, any or all of prior embodiments in this paragraph up through the first embodiment in this paragraph wherein the deuterated anion exchange polymer comprises a plurality of repeating units of formula (I)

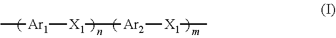

wherein Ar₁ is selected from the group consisting of

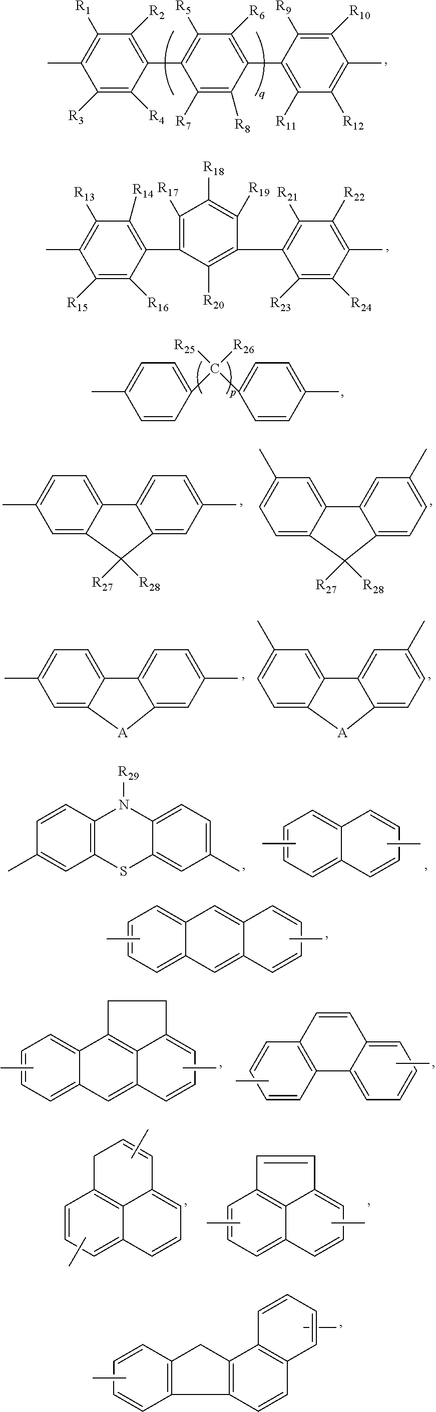

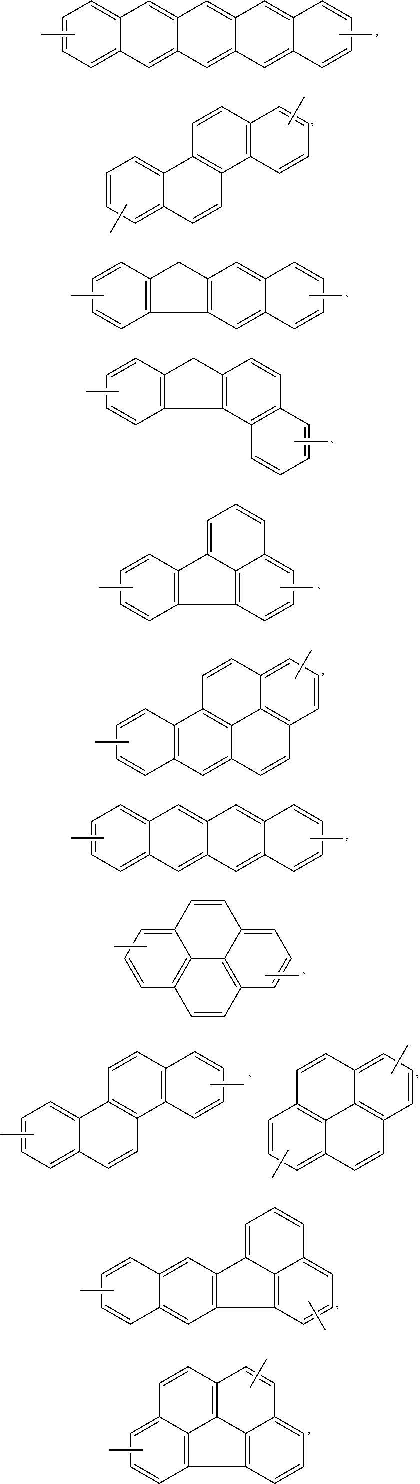

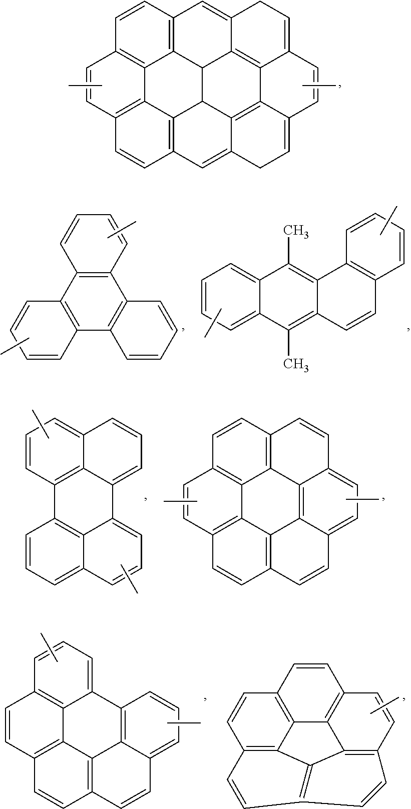

and mixtures thereof;
Ar₂ is selected from the group consisting of

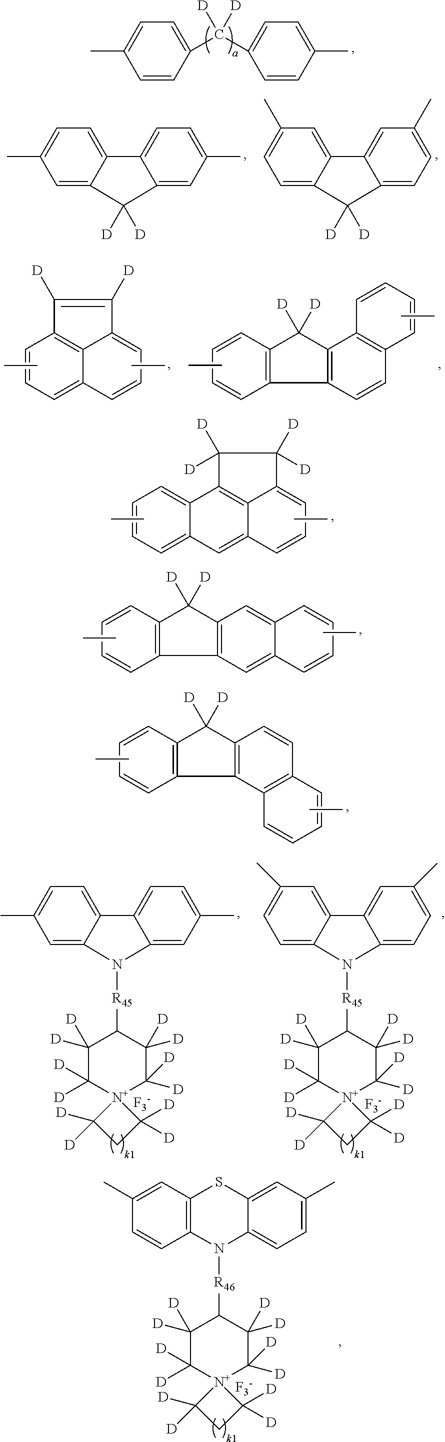

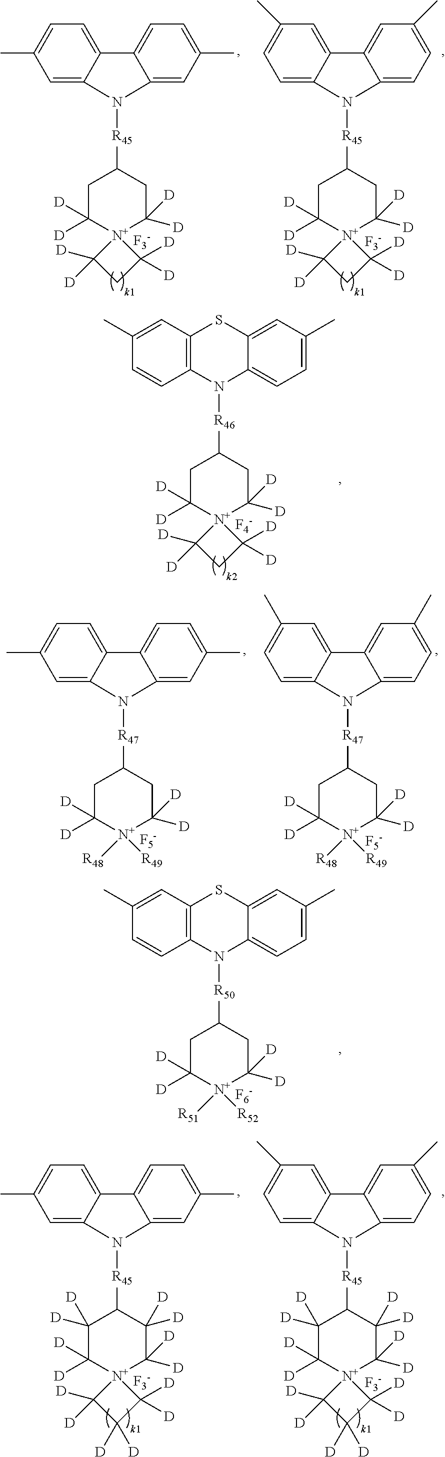

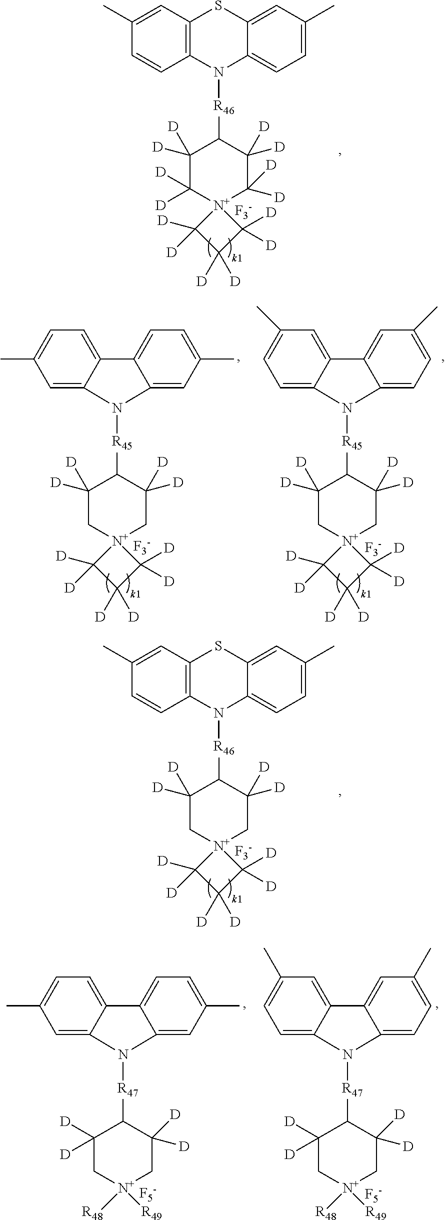

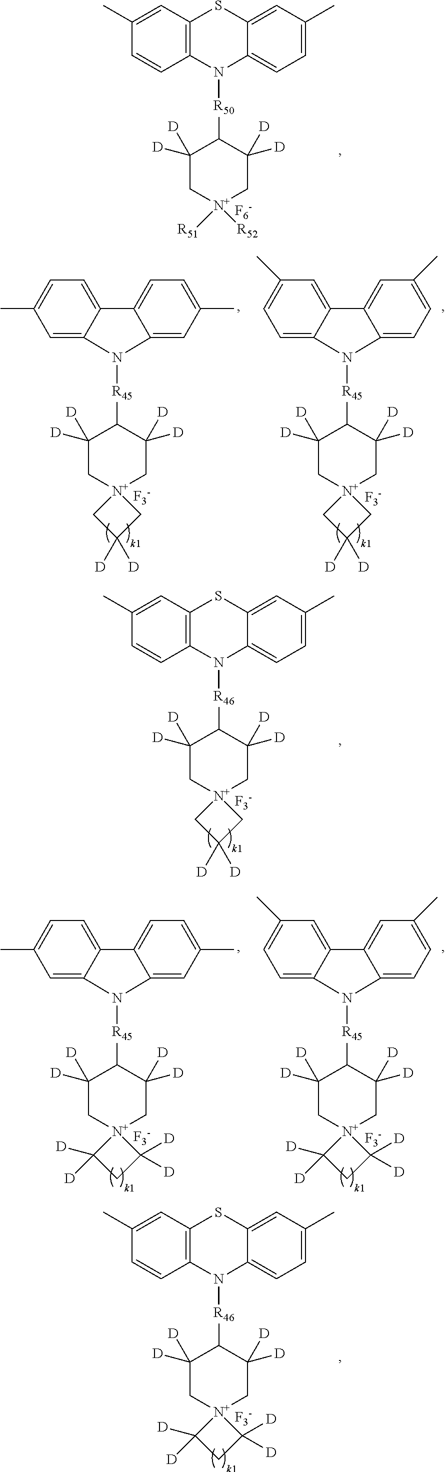

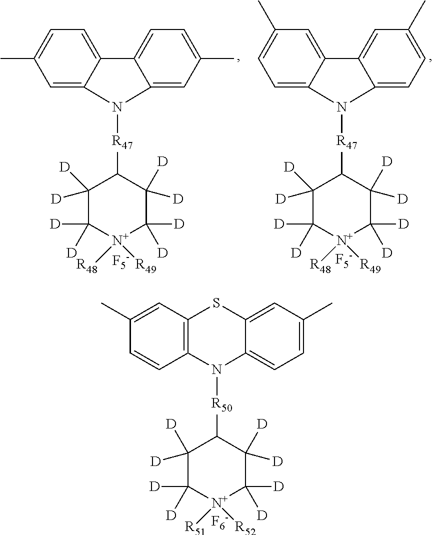

and mixtures thereof;
X₁ is selected from the
group consisting of

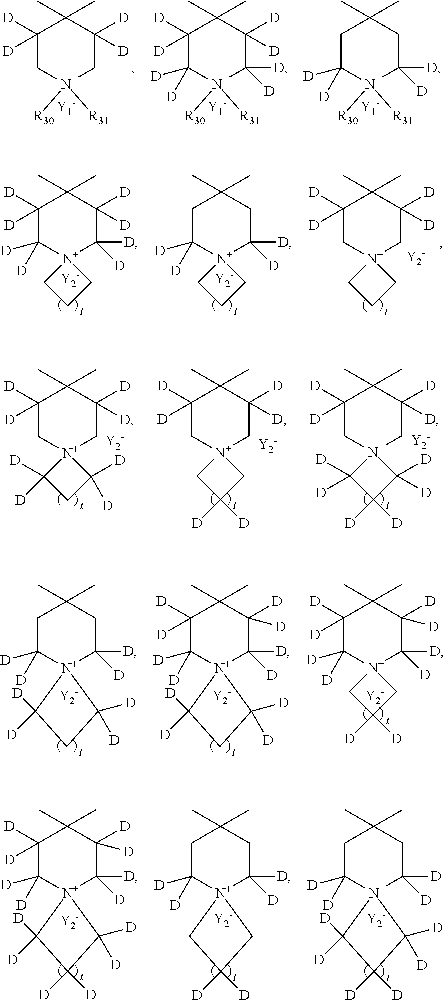

optionally,

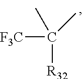

and mixtures thereof;
wherein F₃⁻-F₆⁻, Y₁⁻, and Y₂⁻ are each independently anions; wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group; wherein R₂₉ is hydrogen, an alkyl group, an alkenyl group, an alkynyl group, or an aryl group, and the alkyl, alkenyl, alkynyl or aryl groups are optionally substituted with a halide or a positively charged functional group; wherein R₃₀-R₃₂ is an alkyl group, an alkenyl group, an alkynyl group, or an aryl group, and the alkyl, alkenyl, alkynyl or aryl group is optionally substituted with a halide or a positively charged functional group; wherein R₄₅-R₅₂ are each independently an alkyl group, an alkenyl group, an aryl group, or combinations thereof; wherein A is O, S, or NR₁₀₀; wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group; wherein n is an integer from 5 to 1,000, m is an integer from 0 to 1,000, and the molar ratio of n/m is in a range of 10 to 150; wherein p is 1, 2, 3, or 4; wherein q is 0, 1, 2, or 3; and wherein a, k₁, k₂, t are independently 1, 2, 3, 4, 5, or 6. An embodiment of the invention is one, any or all of prior embodiments in this paragraph up through the first embodiment in this paragraph wherein Ar₁ is selected from the group consisting of

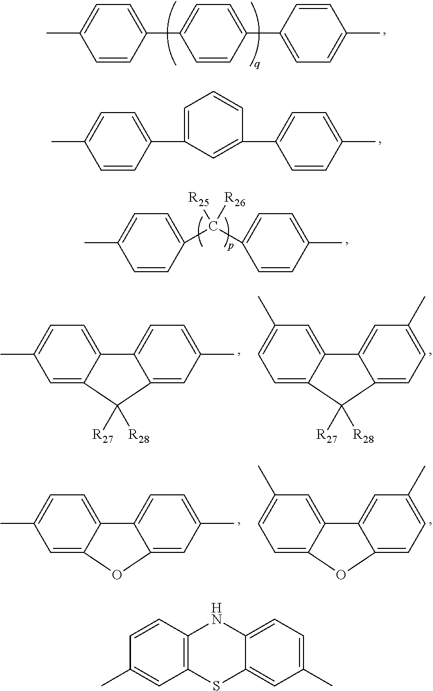

and mixtures thereof; wherein R₂₅, R₂₆, R₂₇, and R₂₈ are each independently —H or —CH₃; wherein p is 1 or 2; and wherein q is 0 or 1. An embodiment of the invention is one, any or all of prior embodiments in this paragraph up through the first embodiment in this paragraph wherein Ar₂ is selected from the group consisting of

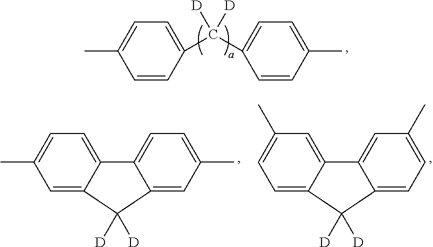

and mixtures thereof, wherein a is 1 or 2. An embodiment of the invention is one, any or all of prior embodiments in this paragraph up through the first embodiment in this paragraph
wherein X₁ is

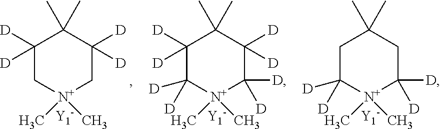

or mixtures thereof; and wherein Y₁⁻ is OH⁻, HCO₃⁻, CH₃COO⁻, CF₃COO⁻, or I⁻. An embodiment of the invention is one, any or all of prior embodiments in this paragraph up through the first embodiment in this paragraph wherein Ar₁ is selected from the group consisting of

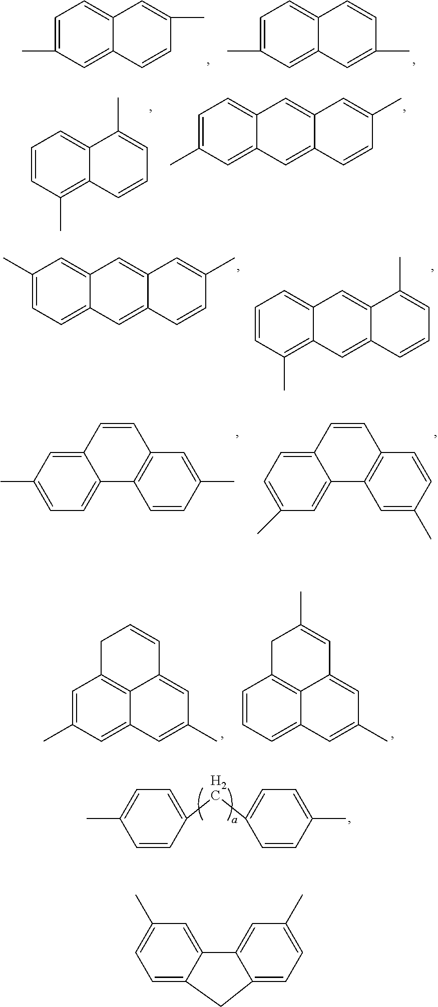

or mixtures thereof, wherein a is 1 or 2. An embodiment of the invention is one, any or all of prior embodiments in this paragraph up through the first embodiment in this paragraph wherein X₁ is selected from the group consisting of

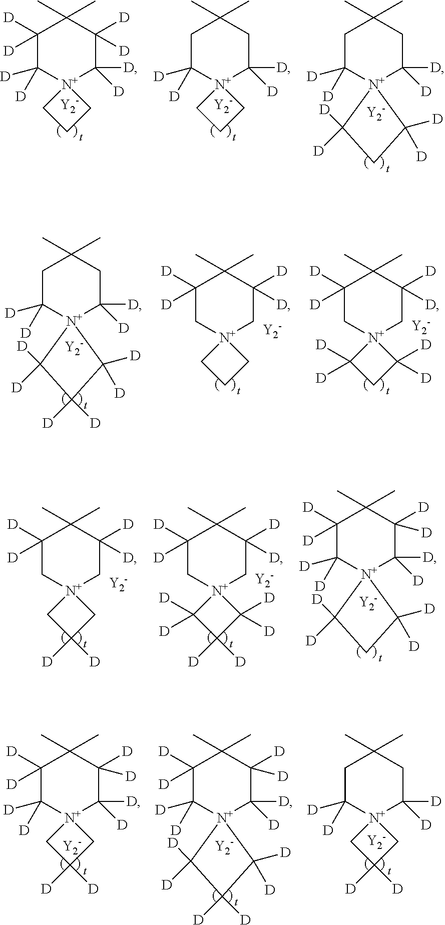

or mixtures thereof, wherein t is 3; and wherein Y₂⁻ is HCO₃⁻, CH₃COO⁻, CF₃COO⁻, OH⁻ or I⁻. An embodiment of the invention is one, any or all of prior embodiments in this paragraph up through the first embodiment in this paragraph wherein X₁ is a mixture of

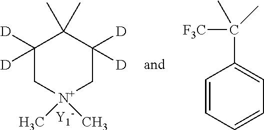

wherein Y₁⁻ is OH⁻, HCO₃⁻, CH₃COO⁻, CF₃COO⁻, or I⁻. An embodiment of the invention is one, any or all of prior embodiments in this paragraph up through the first embodiment in this paragraph wherein X₁ is a mixture of

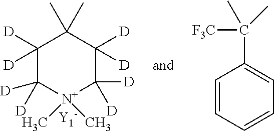

wherein Y₁⁻ is OH⁻, HCO₃⁻, CH₃COO⁻, CF₃COO⁻, or I⁻. An embodiment of the invention is one, any or all of prior embodiments in this paragraph up through the first embodiment in this paragraph wherein X₁ is a mixture of

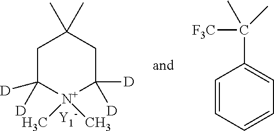

wherein Y₁⁻ is OH⁻, HCO₃⁻, CH₃COO⁻, CF₃COO⁻, or I⁻.

A second embodiment of the invention is a method of making a deuterated anion exchange polymer comprising reacting a deuterated monomer X₁′ with monomer Ar₁′ and deuterated monomer Ar₂′ via a polyhydroxyalkylation reaction in the presence of a super acid or deuterated super acid catalyst to synthesize a neutral precursor polymer; and a Menshutkin reaction to convert the neutral precursor polymer to the deuterated anion exchange polymer comprising a plurality of repeating units of formula (I), wherein Ar₁′ is selected from the group consisting of

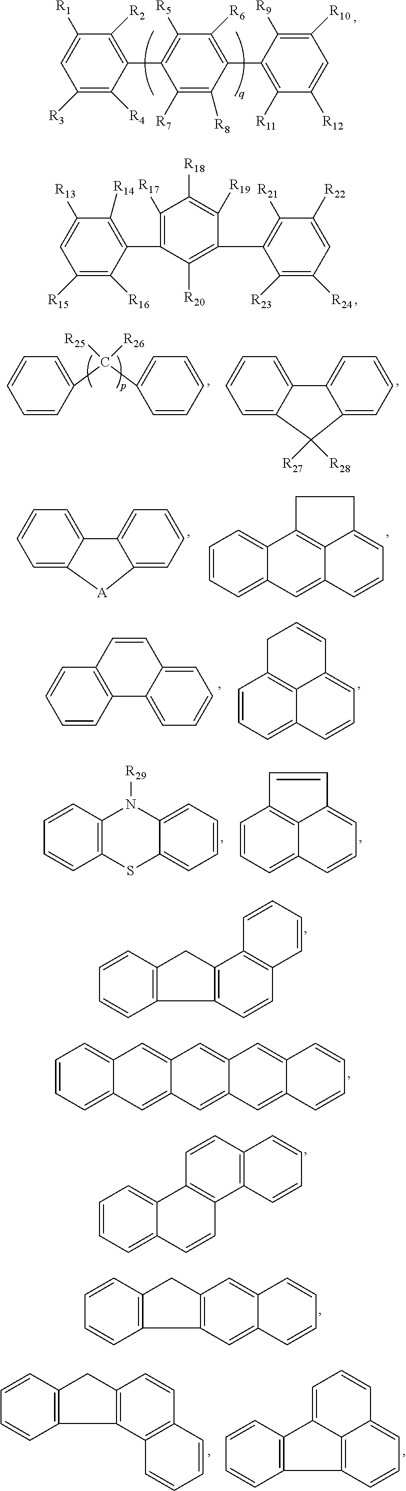

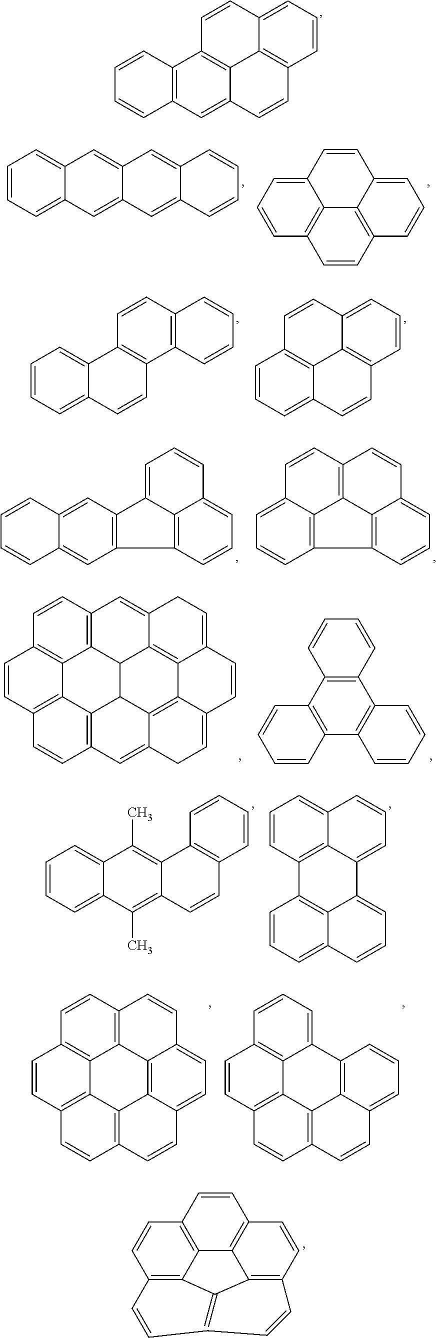

and mixtures thereof;
Ar₂′ is selected from the group consisting of

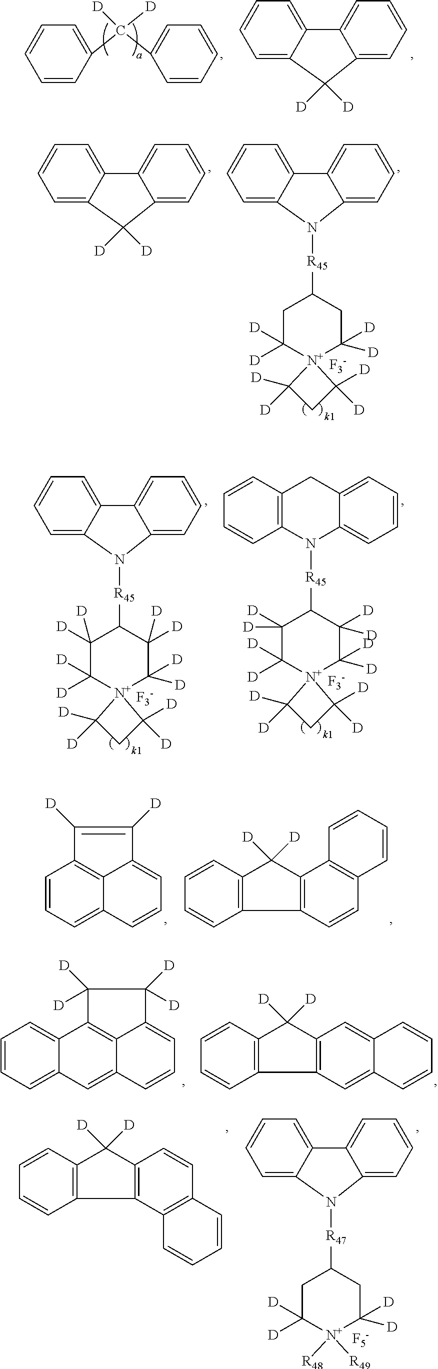

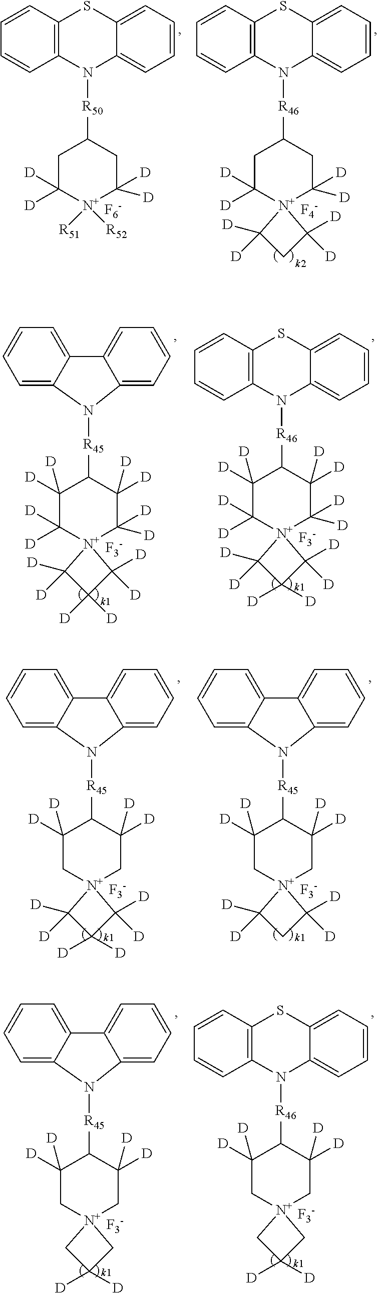

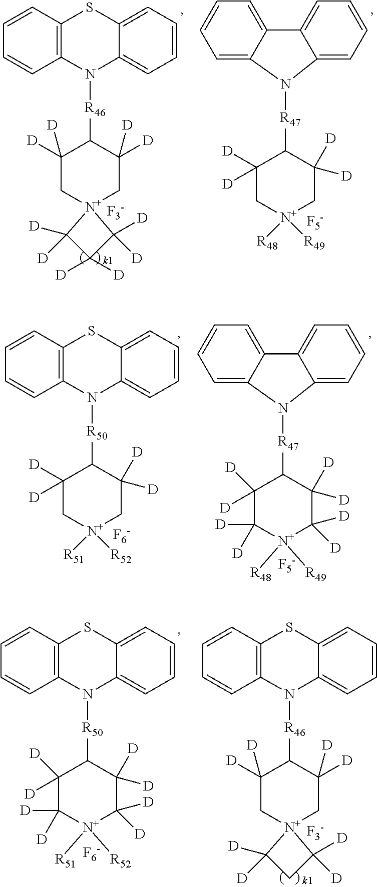

and
mixtures thereof; and
X₁′ is selected from the group consisting of

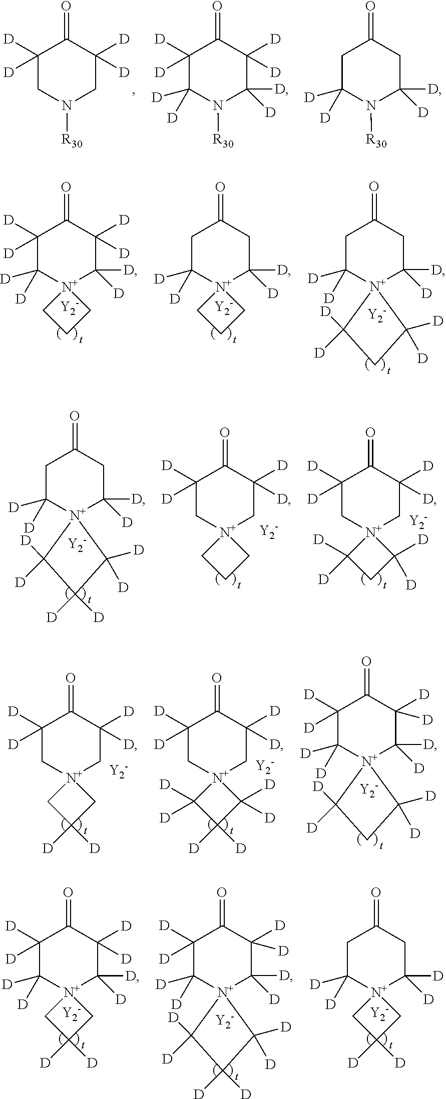

optionally

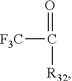

and mixtures thereof; wherein F₃⁻-F₆⁻, Y₂⁻ are independently anions; wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group; wherein R₂₉-R₃₀ is are each independently hydrogen, an alkyl group, an alkenyl group, an alkynyl group, or an aryl group, and the alkyl, alkenyl, alkynyl or aryl groups are optionally substituted with a halide or a positively charged functional group; wherein R₃₂ is an alkyl group, an alkenyl group, an alkynyl group, or an aryl group, and the alkyl, alkenyl, alkynyl or aryl group is optionally substituted with a halide or a positively charged functional group; wherein R₄₅-R₅₂ are each independently an alkyl group, an alkenyl group, an aryl group, or combinations thereof; wherein A is O, S, or NR₁₀₀; wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group; wherein n is an integer from 5 to 1,000, m is an integer from 0 to 1,000, and the molar ratio of n/m is in a range of 10 to 150; wherein p is 1, 2, 3, or 4; wherein q is 0, 1, 2, or 3; and wherein a, k₁, k₂, t are independently 1, 2, 3, 4, 5, or 6. An embodiment of the invention is one, any or all of prior embodiments in this paragraph up through the second embodiment in this paragraph wherein Ar₁′ is selected from the group consisting of

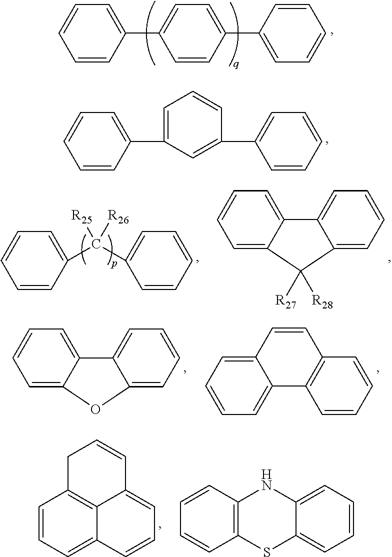

and mixtures thereof; wherein R₂₅, R₂₆, R₂₇, and R₂₈ are each independently —H or —CH₃; wherein p is 1 or 2; and wherein q is 0 or 1. An embodiment of the invention is one, any or all of prior embodiments in this paragraph up through the second embodiment in this paragraph wherein Ar₂′ is selected from the group consisting of

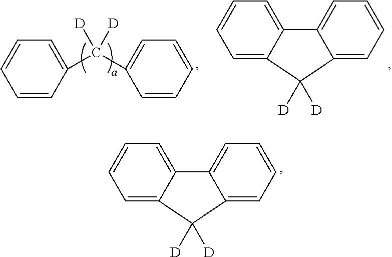

and mixtures thereof, wherein a is 1 or 2. An embodiment of the invention is one, any or all of prior embodiments in this paragraph up through the second embodiment in this paragraph wherein X₁′ is

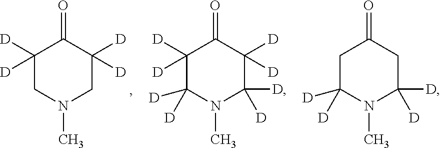

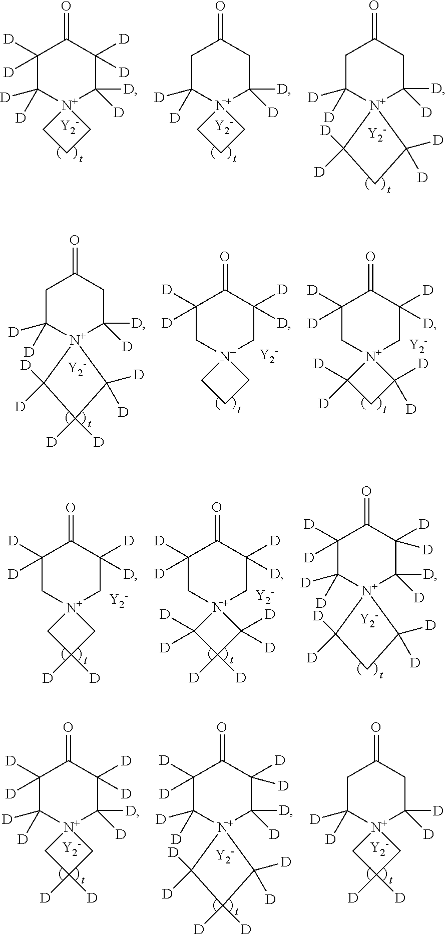

optionally

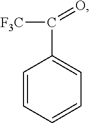 [SMILES: O=C(c1ccccc1)C(F)(F)F]

and mixtures thereof, wherein t is 3; and wherein Y₁⁻ and Y₂⁻ are independently HCO₃⁻, CH₃COO⁻, CF₃COO⁻, OH⁻ or I⁻.

A third embodiment of the invention is an anion exchange membrane comprising a deuterated anion exchange polymer. An embodiment of the invention is one, any or all of prior embodiments in this paragraph up through the third embodiment in this paragraph wherein the deuterated anion exchange polymer comprises the deuterated polymer of any one of the first embodiments. An embodiment of the invention is one, any or all of prior embodiments in this paragraph up through the third embodiment in this paragraph, wherein the deuterated anion exchange membrane is used in a fuel cell, an electrolyzer, a flow battery, an electrodialyzer, a waste metal recovery system, an electrocatalytic hydrogen production system, a desalinator, a water purifier, a waste water treatment system, an ion exchanger, or a CO₂ separator. An embodiment of the invention is one, any or all of prior embodiments in this paragraph up through the third embodiment in this paragraph wherein the deuterated anion exchange membrane comprises a nonporous symmetric dense film membrane, an integrally-skinned asymmetric membrane, a reinforced composite membrane, or a thin film composite membrane. An embodiment of the invention is one, any or all of prior embodiments in this paragraph up through the third embodiment in this paragraph wherein the integrally-skinned asymmetric membrane, the reinforced composite membrane, or the thin film composite membrane comprises a porous substrate material impregnated or coated with the deuterated anion exchange polymer.

A fourth embodiment of the invention is a membrane electrode assembly, comprising a deuterated anion exchange membrane comprising a deuterated anion exchange polymer; a cathode comprising a cathode catalyst on a first surface of the deuterated anion exchange membrane; and optionally an anode comprising an anode catalyst on a second surface of the deuterated anion exchange membrane. An embodiment of the invention is one, any or all of prior embodiments in this paragraph up through the fourth embodiment in this paragraph wherein the deuterated anion exchange polymer comprises the deuterated anion exchange polymer of any one of the first embodiments. An embodiment of the invention is one, any or all of prior embodiments in this paragraph up through the fourth embodiment in this paragraph further comprising a cathode porous transport layer adjacent to the cathode; and an anode porous transport layer adjacent to the anode or an anode catalyst-coated anode porous transport layer adjacent to the deuterated anion exchange membrane.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A deuterated anion exchange polymer for electrochemical reactions.

2. The deuterated anion exchange polymer of claim 1 wherein the electrochemical reactions comprise water electrolysis, CO₂ electrolysis, fuel cell, and flow battery.

3. The deuterated anion exchange polymer of claim 1 wherein the deuterated anion exchange polymer comprises a plurality of repeating units of formula (I) 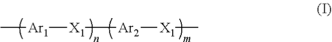
wherein Ar₁ is selected from the group consisting of: 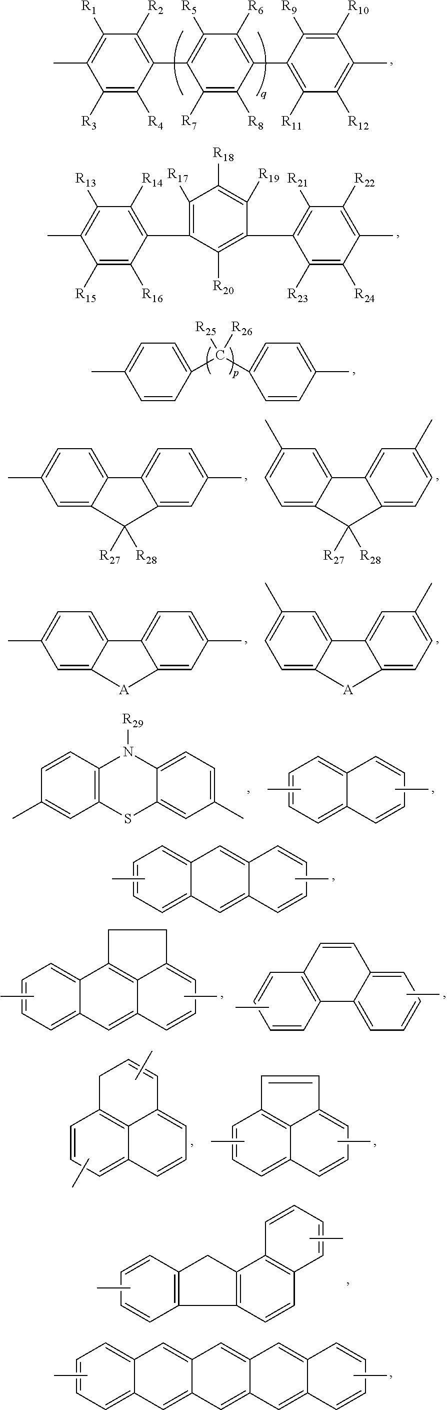 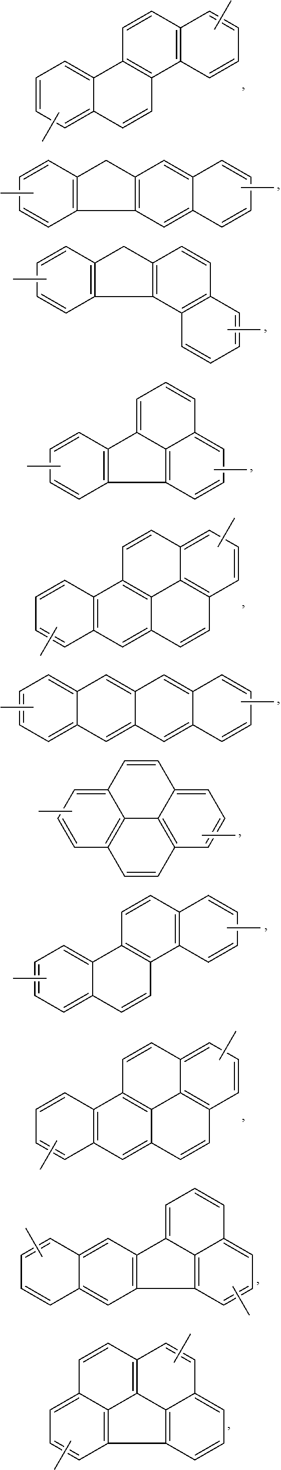 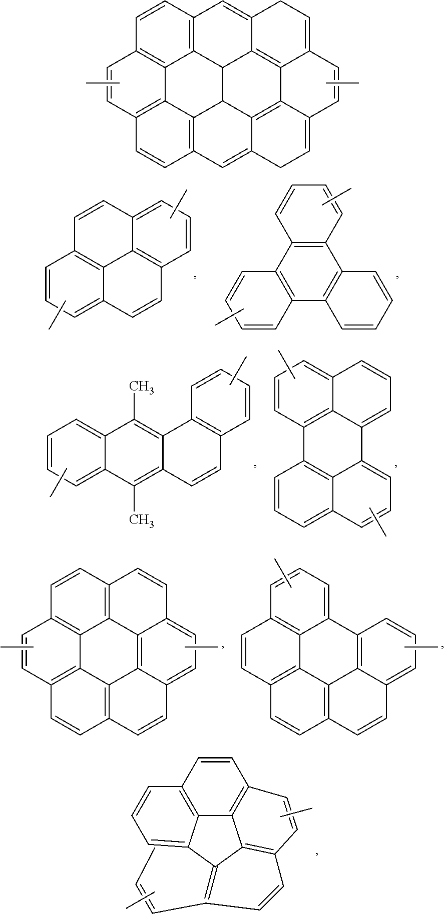
and mixtures thereof;
Ar₂ is selected from the group consisting of: 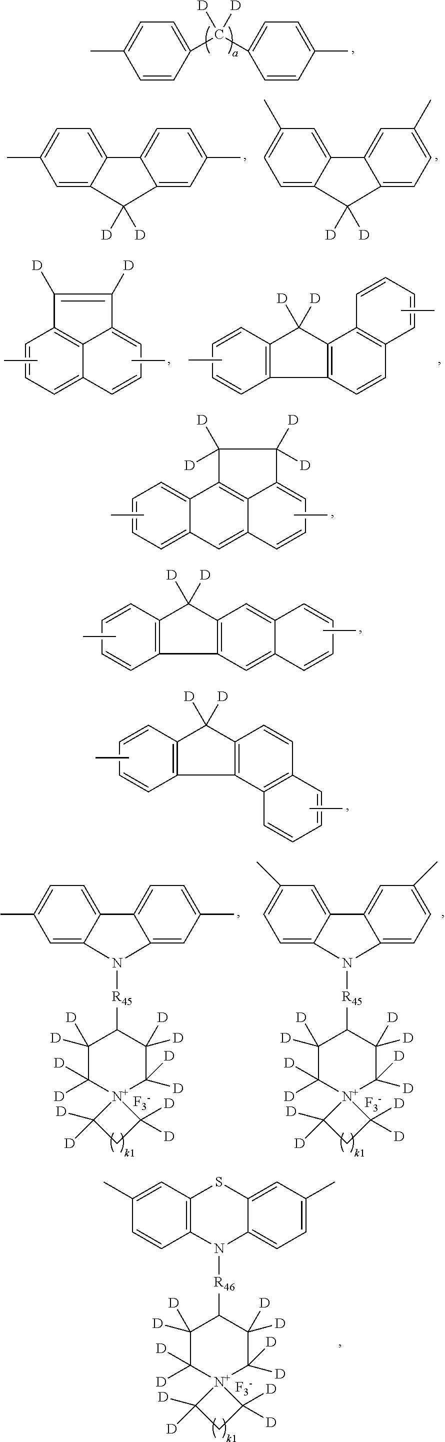 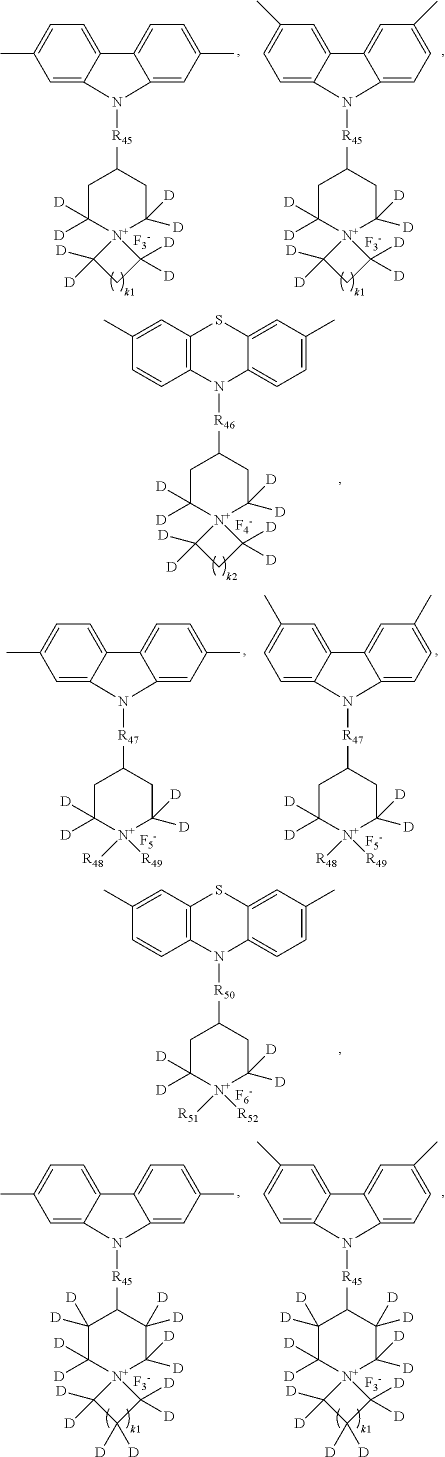 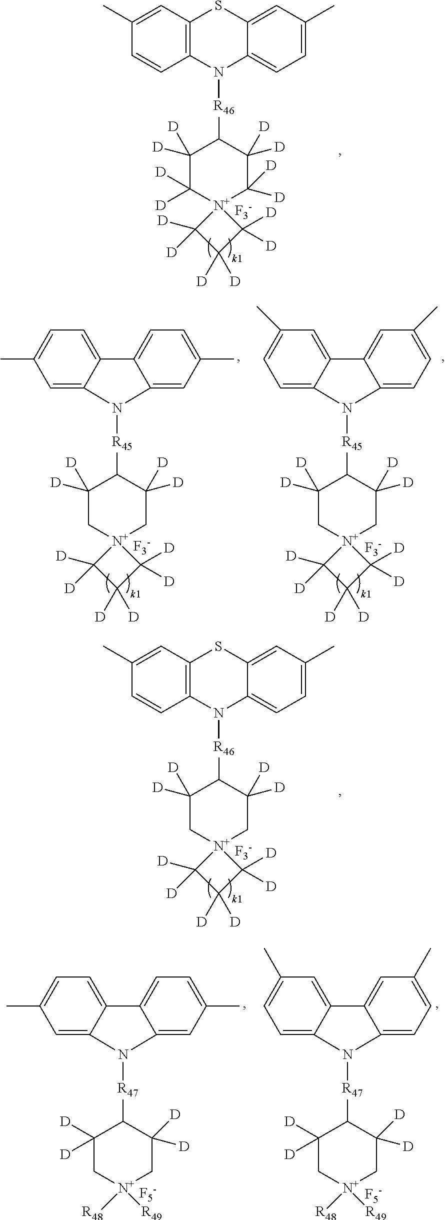 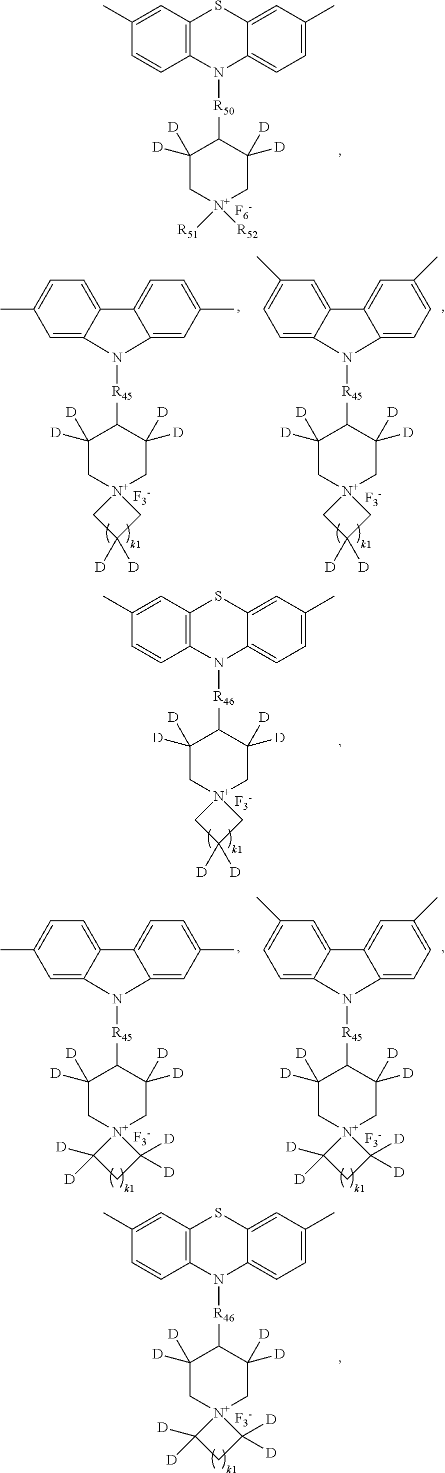 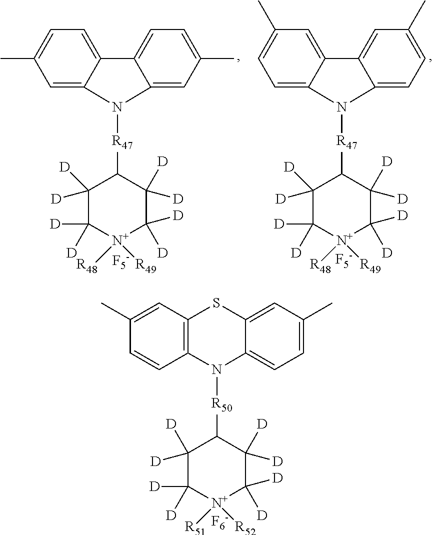
and mixtures thereof;
X₁ is selected from the group consisting of: 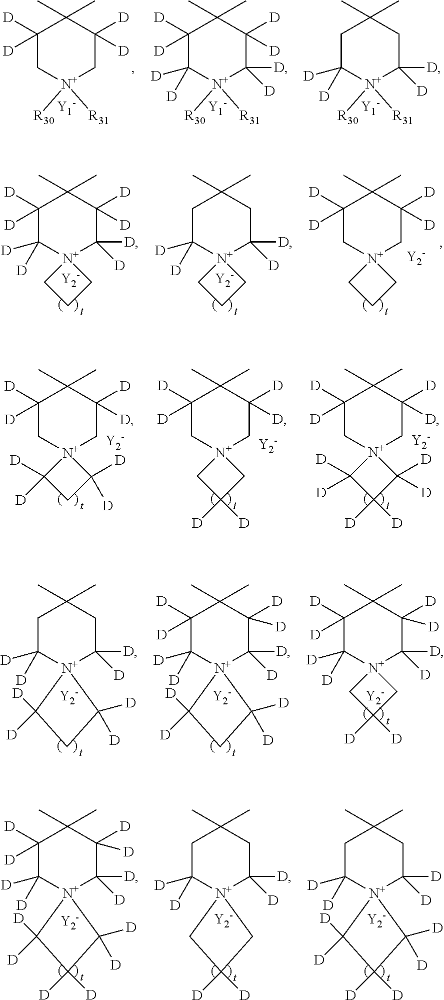
optionally 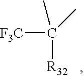
and mixtures thereof;
wherein F₃⁻-F₆⁻, Y₁⁻, and Y₂⁻ are each independently anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉ is hydrogen, an alkyl group, an alkenyl group, an alkynyl group, or an aryl group, and the alkyl, alkenyl, alkynyl or aryl groups are optionally substituted with a halide or a positively charged functional group;
wherein R₃₀-R₃₂ is an alkyl group, an alkenyl group, an alkynyl group, or an aryl group, and the alkyl, alkenyl, alkynyl or aryl group is optionally substituted with a halide or a positively charged functional group;
wherein R₄₅-R₅₂ are each independently an alkyl group, an alkenyl group, an aryl group, or combinations thereof;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 5 to 1,000, m is an integer from 0 to 1,000, and the molar ratio of n/m is in a range of 1:0 to 1:50;
wherein p is 1, 2, 3, or 4;
wherein q is 0, 1, 2, or 3; and
wherein a, k₁, k₂, t are independently 1, 2, 3, 4, 5, or 6.

4. The deuterated anion exchange polymer of claim 3 wherein Ar₁ is selected from the group consisting of 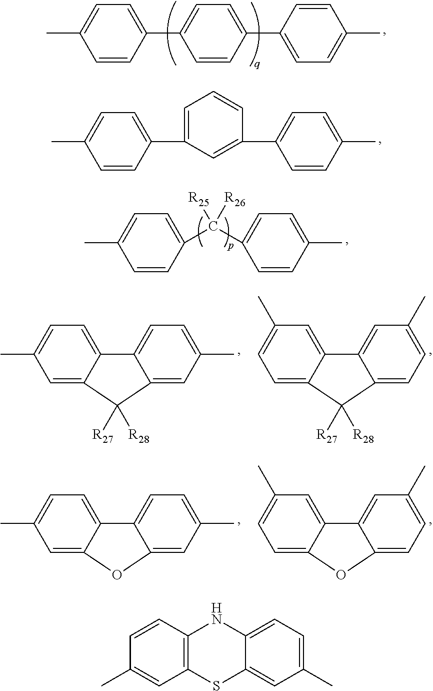
and mixtures thereof;
wherein R₂₅, R₂₆, R₂₇, and R₂₈ are each independently —H or —CH₃;
wherein p is 1 or 2; and
wherein q is 0 or 1.

5. The deuterated anion exchange polymer of claim 3 wherein Ar₂ is selected from the group consisting of 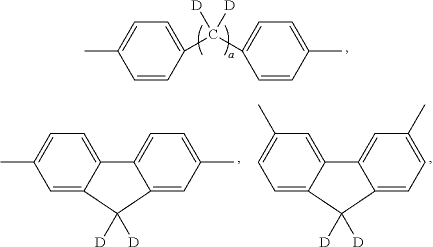
and mixtures thereof,
wherein a is 1 or 2.

6. The deuterated anion exchange polymer of claim 3 wherein X₁ is 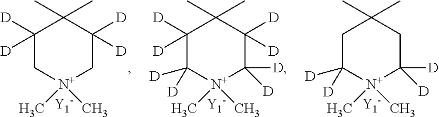
or mixtures thereof; and
wherein Y₁⁻ is OH⁻, HCO₃⁻, CH₃COO⁻, CF₃COO⁻, or I⁻.

7. The deuterated anion exchange polymer of claim 3 wherein Ar₁ is selected from the group consisting of 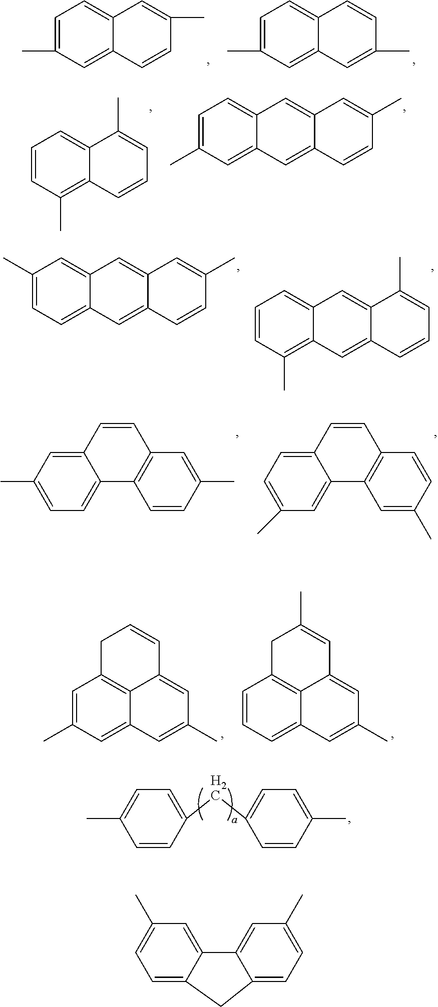
or mixtures thereof,
wherein a is 1 or 2.

8. The deuterated anion exchange polymer of claim 3 wherein X₁ is selected from the group consisting of 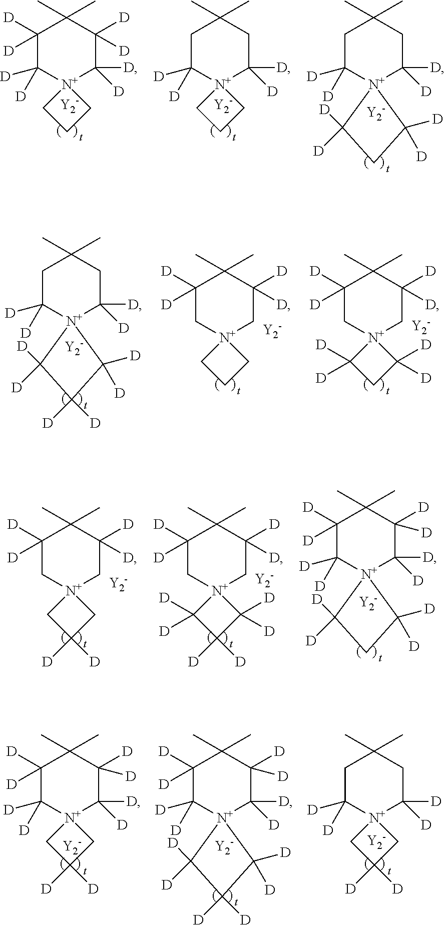
or mixtures thereof,
wherein t is 3; and
wherein Y₂⁻ is HCO₃⁻, CH₃COO⁻, CF₃COO⁻, OH⁻ or I⁻.

9. The deuterated anion exchange polymer of claim 3 wherein X₁ is a mixture of 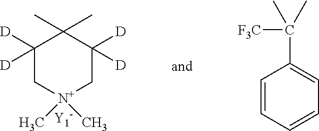
wherein Y₁⁻ is OH⁻, HCO₃⁻, CH₃COO⁻, CF₃COO⁻, or I⁻.

10. The deuterated anion exchange polymer of claim 3 wherein X₁ is a mixture of 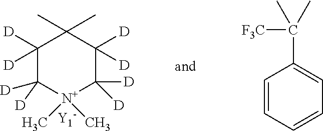
wherein Y₁⁻ is OH⁻, HCO₃⁻, CH₃COO⁻, CF₃COO⁻, or I⁻.

11. The deuterated anion exchange polymer of claim 3 wherein X₁ is a mixture of 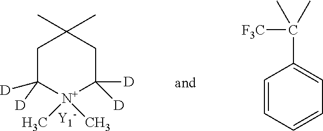
wherein Y₁⁻ is OH⁻, HCO₃⁻, CH₃COO⁻, CF₃COO⁻, or I⁻.

12. A method of making a deuterated anion exchange polymer 1 wherein the deuterated anion exchange polymer comprises a plurality of repeating units of formula (I) 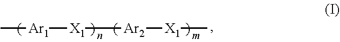
The method comprising:
reacting a deuterated monomer X₁′ with monomer Ar₁′ and deuterated monomer Ar₂′ via a polyhydroxyalkylation reaction in the presence of a super acid or deuterated super acid catalyst to synthesize a neutral precursor polymer; and a Menshutkin reaction to convert the neutral precursor polymer to the deuterated anion exchange polymer comprising a plurality of repeating units of formula (I), wherein Ar₁′ is selected from the group consisting of: 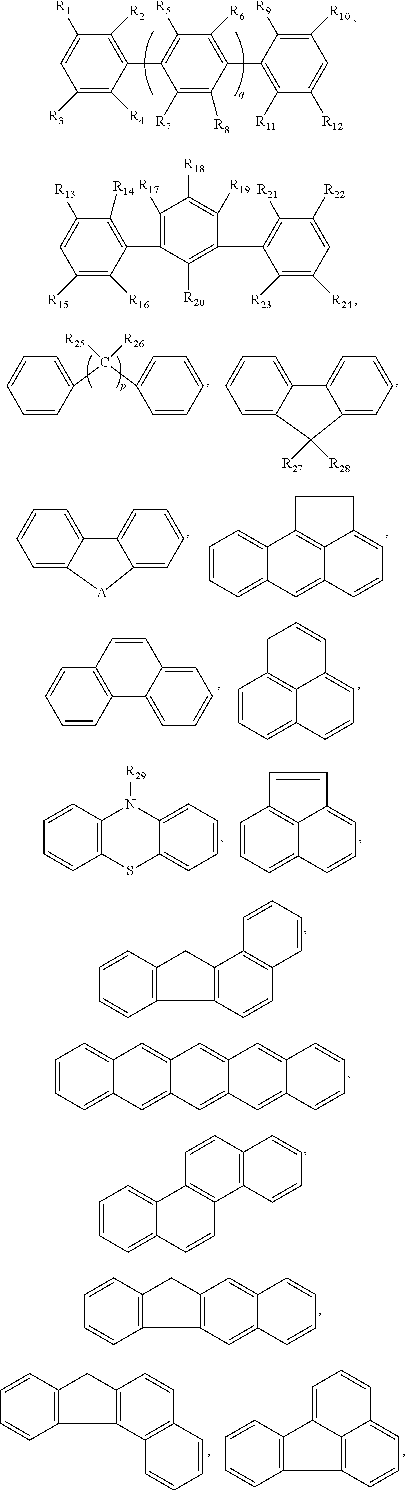 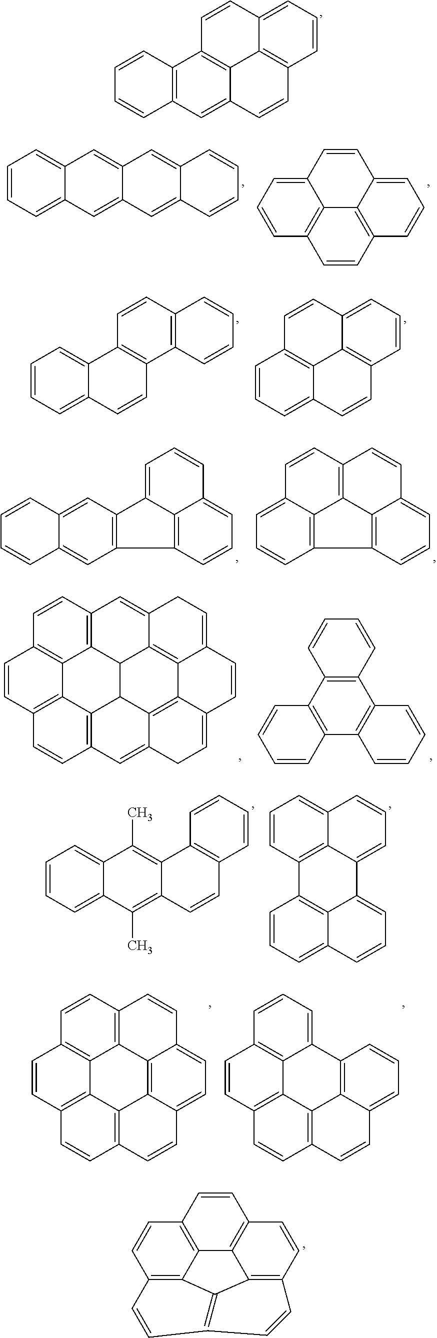
and mixtures thereof;
Ar₂′ is selected from the group consisting of: 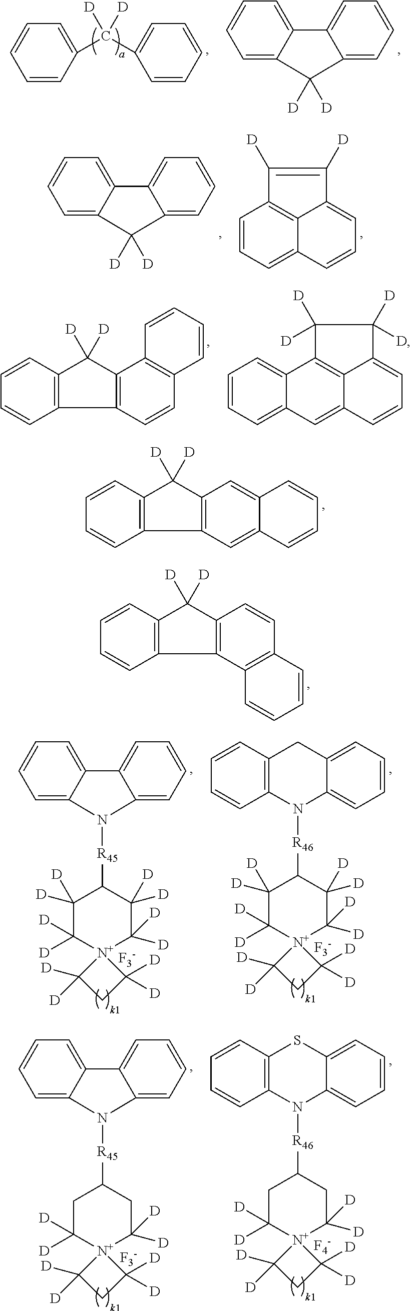 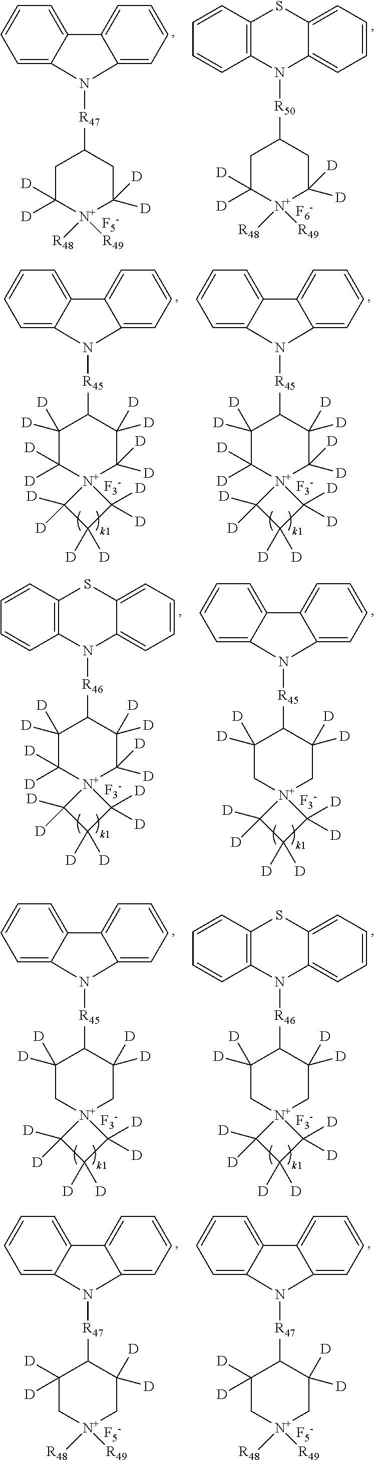 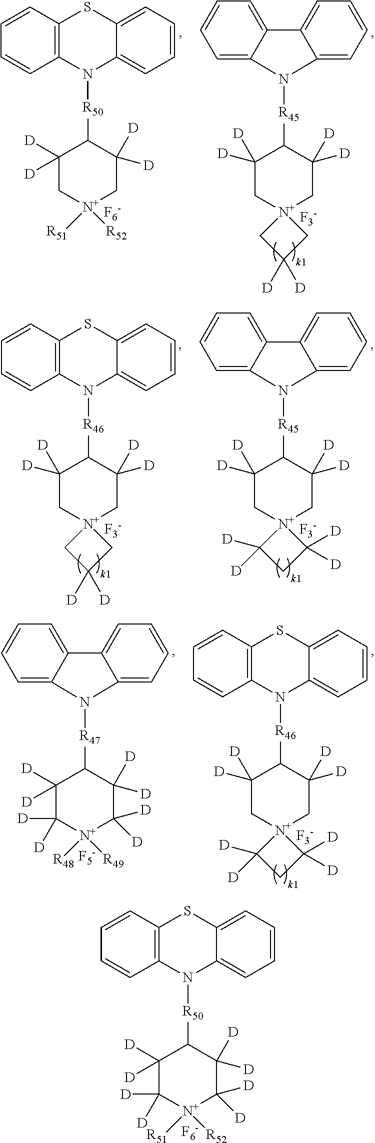
and mixtures thereof; and
X₁′ is selected from the group consisting of: 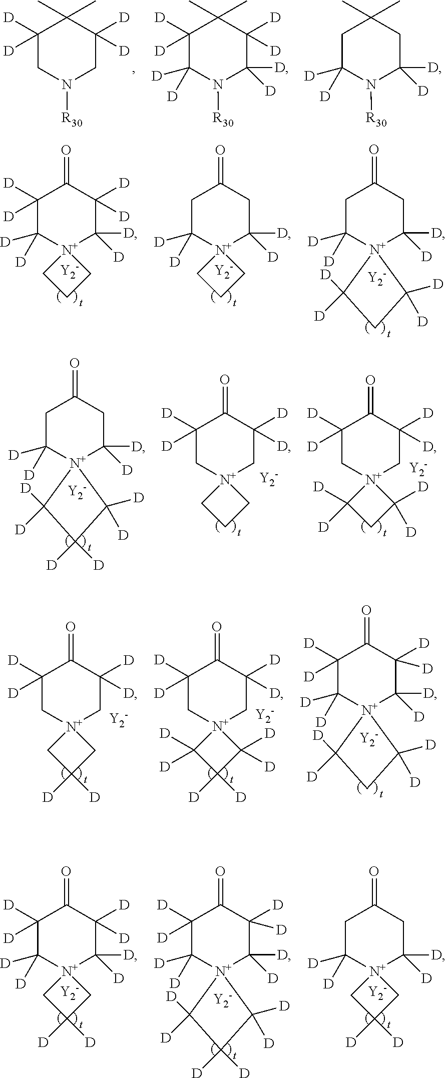
optionally 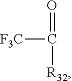
and mixtures thereof;
wherein F₃⁻-F₆⁻, Y₂⁻ are independently anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉-R₃₀ is are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein R₄₅-R₅₂ are each independently an alkyl group, an alkenyl group, an aryl group, or combinations thereof;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 5 to 1,000, m is an integer from 0 to 1,000, and the molar ratio of n/m is in a range of 1:0 to 1:50;
wherein p is 1, 2, 3, or 4;
wherein q is 0, 1, 2, or 3; and
wherein a, k₁, k₂, t are independently 1, 2, 3, 4, 5, or 6.

13. The method of claim 12 wherein Ar₁′ is selected from the group consisting of: 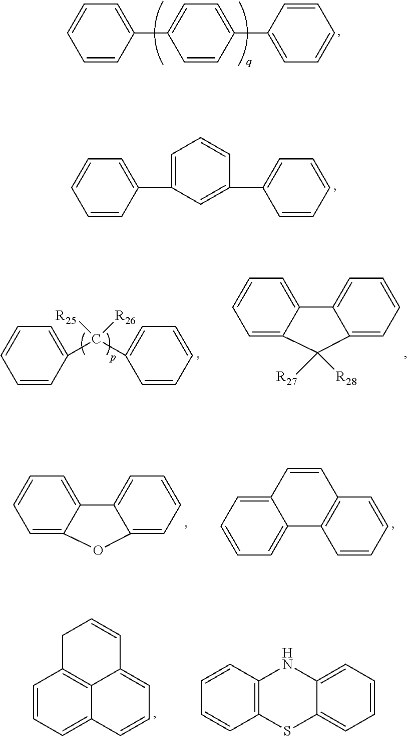
and mixtures thereof;
wherein R₂₅, R₂₆, R₂₇, and R₂₈ are each independently —H or —CH₃;
wherein p is 1 or 2; and
wherein q is 0 or 1.

14. The method of claim 12 wherein Ar₂′ is selected from the group consisting of: 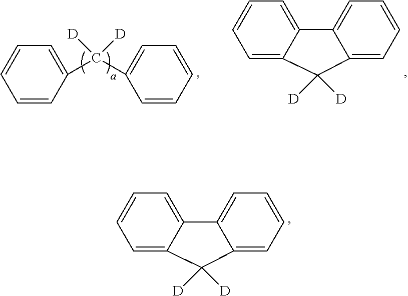
and mixtures thereof,
wherein a is 1 or 2.

15. The method of claim 12 wherein X₁′ is 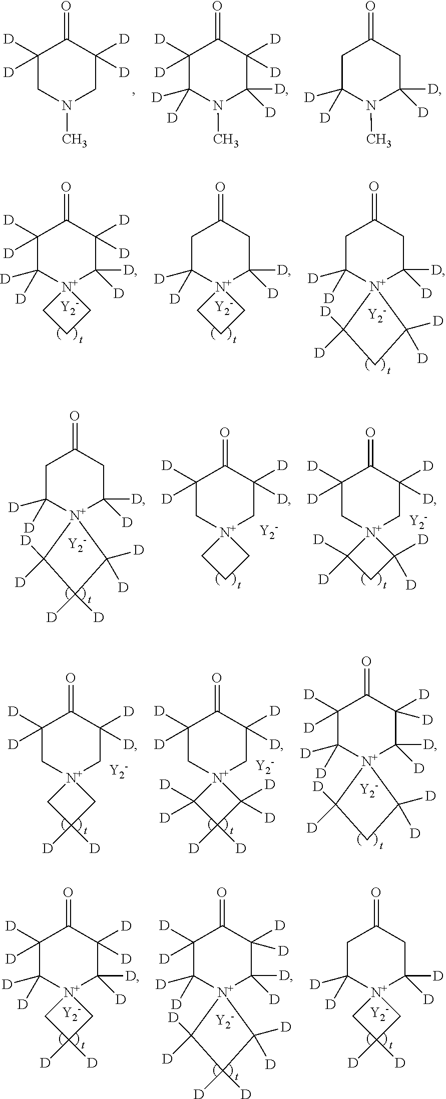
optionally 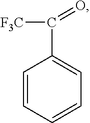 [SMILES: O=C(c1ccccc1)C(F)(F)F]
and mixtures thereof,
wherein t is 3; and
wherein Y₁⁻ and Y₂⁻ are independently HCO₃⁻, CH₃COO⁻, CF₃COO⁻, OH⁻ or I⁻.

16. An anion exchange membrane comprising a deuterated anion exchange polymer.

17. The ion exchange membrane of claim 16 wherein the deuterated anion exchange polymer comprises a plurality of repeating units of formula (I) 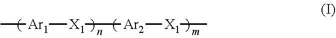
wherein Ar₁ is selected from the group consisting of: 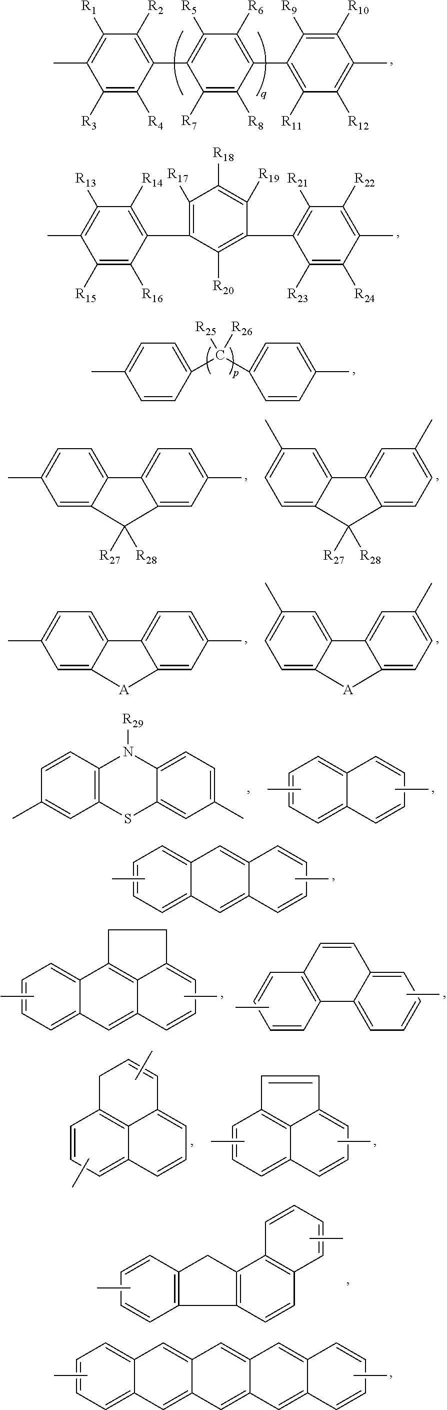 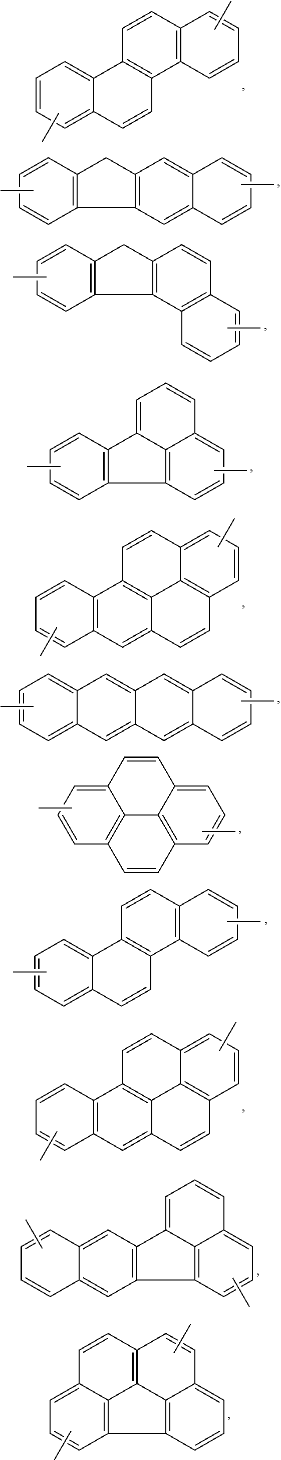 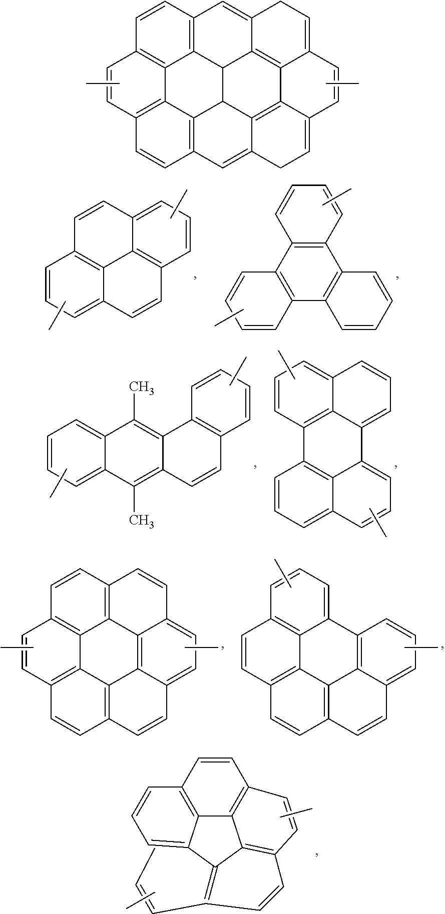
and mixtures thereof:
Ar₂ is selected from the group consisting of: 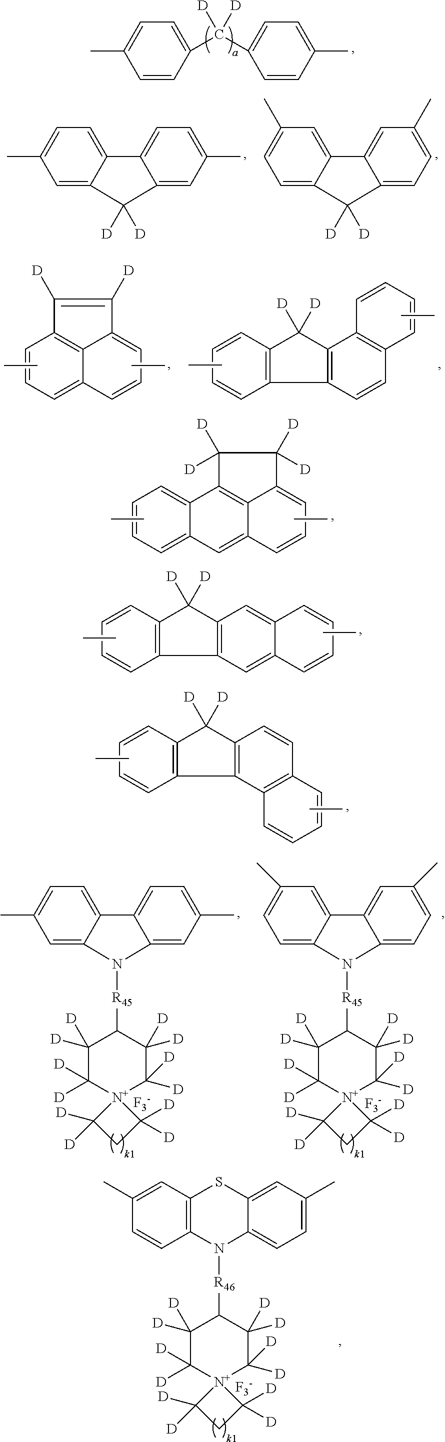 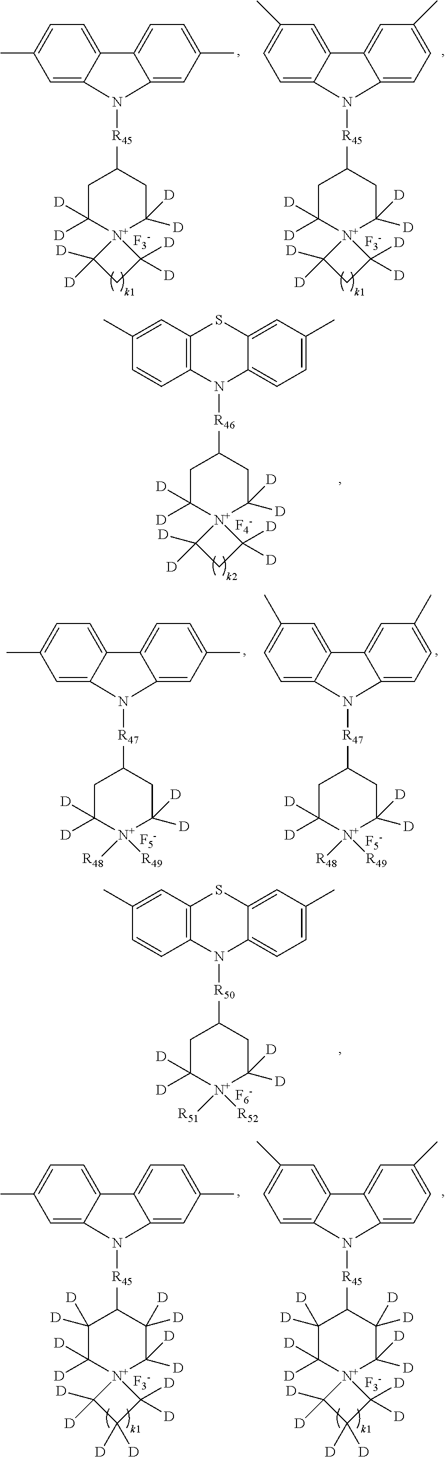 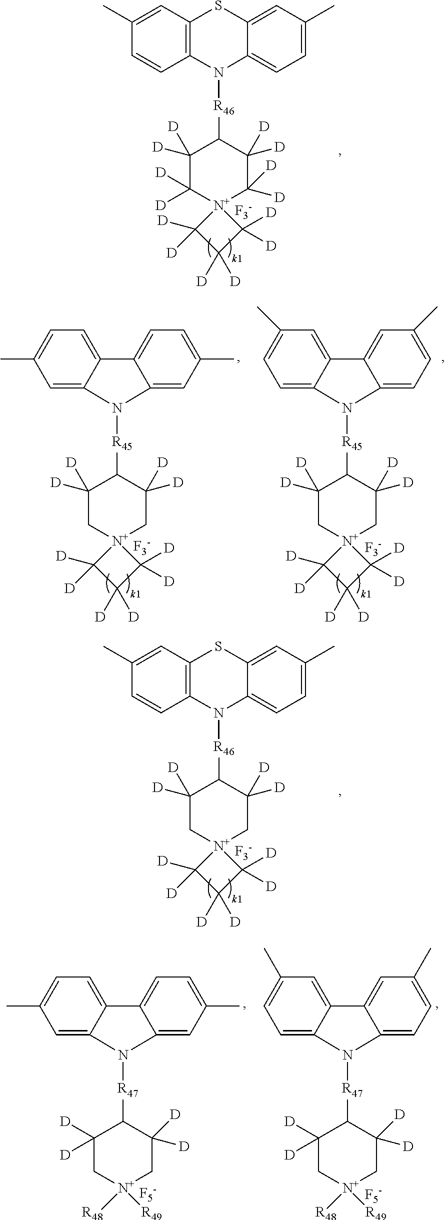 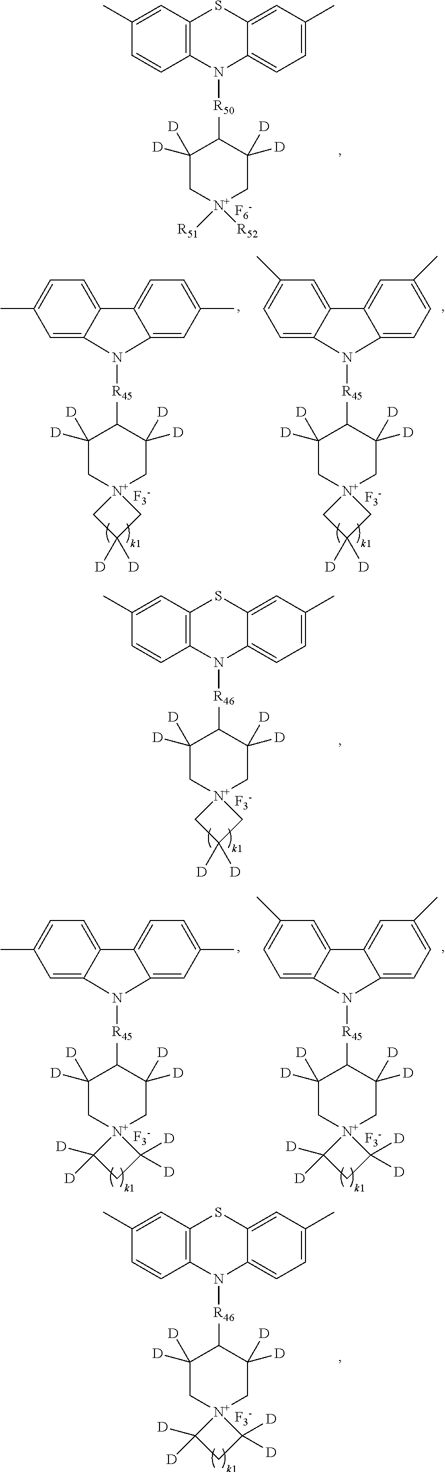 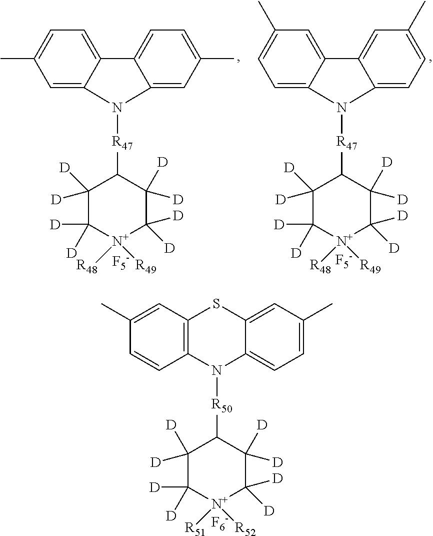
and mixtures thereof;
X₁ is selected from the group consisting of: 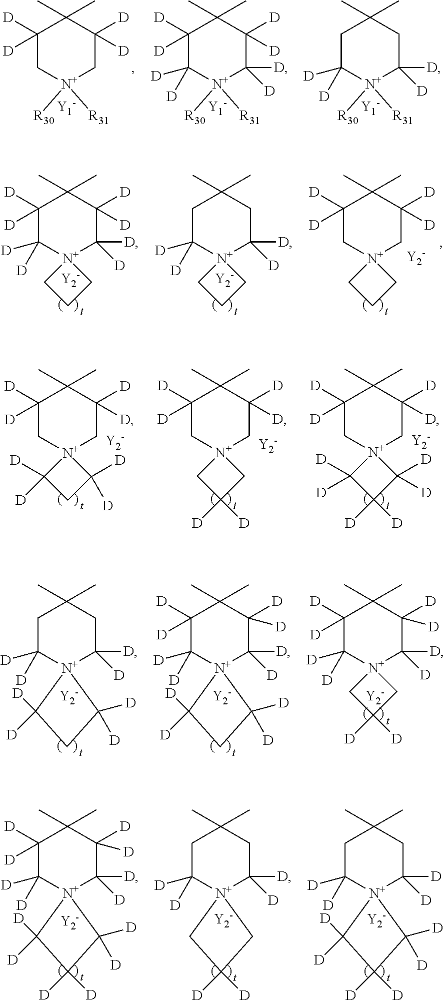
optionally 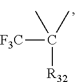
and mixtures thereof;
wherein F₃⁻-F₆⁻, Y₁⁻, and Y₂⁻ are each independently anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉ is hydrogen, an alkyl group, an alkenyl group, an alkynyl group, or an aryl group, and the alkyl, alkenyl, alkynyl or aryl groups are optionally substituted with a halide or a positively charged functional group;
wherein R₃₀-R₃₂ is an alkyl group, an alkenyl group, an alkynyl group, or an aryl group, and the alkyl, alkenyl, alkynyl or aryl group is optionally substituted with a halide or a positively charged functional group;
wherein R₄₅-R₅₂ are each independently an alkyl group, an alkenyl group, an aryl group, or combinations thereof;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 5 to 1,000, m is an integer from 0 to 1,000, and the molar ratio of n/m is in a range of 1:0 to 1:50;
wherein p is 1, 2, 3, or 4;
wherein q is 0, 1, 2, or 3; and
wherein a, k₁, k₂, t are independently 1, 2, 3, 4, 5, or 6.

18. The deuterated anion exchange membrane of claim 16, wherein the deuterated anion exchange membrane is used in a fuel cell, an electrolyzer, a flow battery, an electrodialyzer, a waste metal recovery system, an electrocatalytic hydrogen production system, a desalinator, a water purifier, a waste water treatment system, an ion exchanger, or a CO₂ separator.

19. The deuterated anion exchange membrane of claim 16 wherein the deuterated anion exchange membrane comprises a nonporous symmetric dense film membrane, an integrally-skinned asymmetric membrane, a reinforced composite membrane, or a thin film composite membrane.

20. The deuterated anion exchange membrane of claim 19 wherein the integrally-skinned asymmetric membrane, the reinforced composite membrane, or the thin film composite membrane comprises a porous substrate material impregnated or coated with the deuterated anion exchange polymer.
